(19) United States
(12) Patent Application Publication
(10) Pub. No.: US 2006/0229930 A9
(43) Pub. Date: Oct. 12, 2006

(54) Method to generate advertising revenue based on time and location

(76) Inventor: Elliot A. Gottfurcht, Los Angeles, CA (US)

Correspondence Address: STEPTOE and JOHNSON LLP, 1330 Connecticut Avenue, NW, WASHINGTON, DC, 20036, US

(21) Appl. No.: 10/646,066

(22) Filed: Aug. 21, 2003

Related U.S. Application Data
(63) Continuation-in-part of application No. 09/518,015, filed on Mar. 3, 2000, now Pat. No. 7,020,845.
Application No. 09/518,015 is a continuation-in-part of application No. 09/440,214, filed on Nov. 15, 1999, now Pat. No. 6,600,497.

(51) Int. Cl. G06F 17/60

(52) U.S. Cl. 705/10; 705/37; 705/1

(57) ABSTRACT

A method and apparatus to facilitate targeted advertisement and listing services to customers using a shopping system. The shopping system may be an interactive television system. The targeted advertising allows for improved targeting by allowing advertisers to bid on advertising space based on the time a user is shopping and the location of the user.

### CROSS-REFERENCE TO RELATED APPLICATIONS

The application is a second Continuation-In-Part of co-pending application Ser. No. 09/518,015, filed Mar. 3, 2000 by applicant, Elliot A. Gottfurcht, et al. entitled “AN APPARATUS AND METHOD FOR SIMPLE WIDE-AREA NETWORK NAVIGATION.”

### BACKGROUND

1. Field

The invention relates to electronic information services and electronic commerce services. More specifically, the invention relates to providing targeted advertising and listing services based on time and location of customers.

2. Description of the Related Art

The importance of the Internet as a tool of electronic commerce can not be overstated. The ability of consumers to buy products, obtain information from the comfort of their own home is revolutionizing the way business is done. Increasingly, there is a push to provide access to the Internet on standard television monitors through the use of set top boxes. Over time, much like cable-ready televisions, it is expected that Internet-ready televisions will proliferate. Unfortunately, even on large screen televisions the web surfing experience is poor, inasmuch as the web content is illegible and/or unnegotiable, unless you happen to be sitting very close to the television. Generally, this makes web surfing impractical in more traditional television environments. As the television web access systems proliferate, improved navigation and content access on the television is likely to become a necessity.

### BRIEF SUMMARY OF THE INVENTION

A method and apparatus to facilitate targeted advertisement and listing services to customers using a shopping system. The shopping system may be an interactive television system. The targeted advertising allows for improved targeting by allowing advertisers to bid on advertising space based on the time a user is shopping and the location of the user.

### BRIEF DESCRIPTION OF THE DRAWINGS

FIG. 1 is a block diagram of a system employing one embodiment of the invention.

FIG. 2a is an exemplary web page having a sister site link.

FIG. 2b is an exemplary first matrix page of a sister site for the web page of FIG. 2a.

FIG. 2c is a web page having irregular segmentation.

FIG. 3 is a flow diagram of conversion of standard HTML pages to a sister site format in one embodiment of the invention.

FIG. 4 is a block diagram of a client hardware architecture of one embodiment of the invention.

FIG. 5a is a flow diagram of server side segmentation in one embodiment of the invention.

FIG. 5b is a flow diagram of client side manipulation of a segmented page in one embodiment of the invention.

FIG. 5c is a diagram showing a system implementing the tab, scroll, and zoom features of one embodiment of the invention.

FIG. 6 is a flow chart of operations of the navigation system of one embodiment of the invention in a custom terminal custom browser node.

FIG. 7 is a flow diagram of operation of the sister site server of one embodiment of the invention.

FIG. 8 is a diagram of the display of a graphical user interface of one embodiment of the invention.

FIGS. 9a-d are examples of sister site matrix pages.

FIGS. 10a-g are a series of matrix layers displayed during an exemplary navigation using one embodiment of the invention.

FIG. 11 shows a history window overlying a navigation matrix layer.

FIGS. 12a and b are an example of a matrix layer of one embodiment of the invention.

FIG. 13 is an e-mail composition matrix layer for one embodiment of the invention.

FIG. 14 shows an alternative matrix of one embodiment of the invention.

FIG. 15 is a diagram of a top level of a navigation hierarchy interface for one embodiment of the invention.

FIG. 16 is diagram of an intermediate level of a navigation hierarchy interface for one embodiment of the invention.

FIG. 17 is diagram of a second intermediate level of a navigation hierarchy interface for one embodiment of the invention.

FIG. 18 is diagram of a lower level of a navigation hierarchy interface for one embodiment of the invention.

FIG. 19 is a diagram of a second lower level of a navigation hierarchy for one embodiment of the invention.

FIG. 20 is a flowchart of a process for providing shopping services via interactive television in one embodiment of the invention.

FIG. 21 is a diagram of an interface for managing an account for an advertiser for interactive television in one embodiment of the invention.

FIG. 22 is a diagram of peripheral input device for use with the simplified navigation system.

### DETAILED DESCRIPTION

A simplified system for navigation of the Internet or other content source allows access to the content and services available thereon with greater ease, on, for example, a display more remote from a user than in the use of the “traditional” personal computer (PC) two foot paradigm.

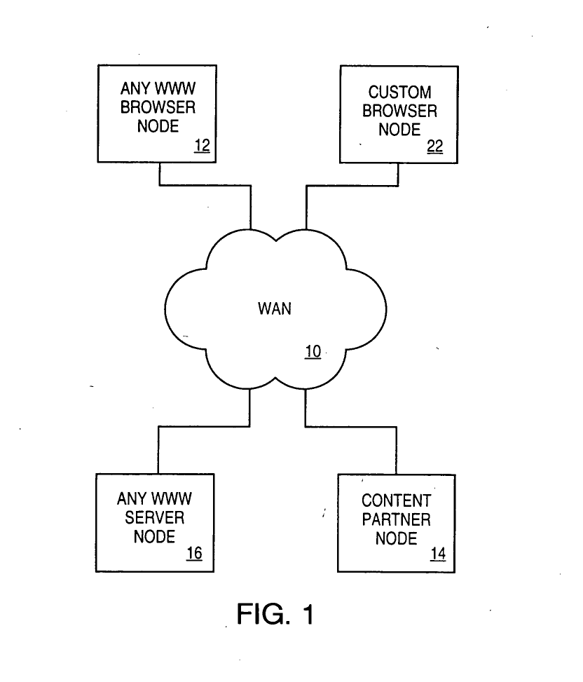

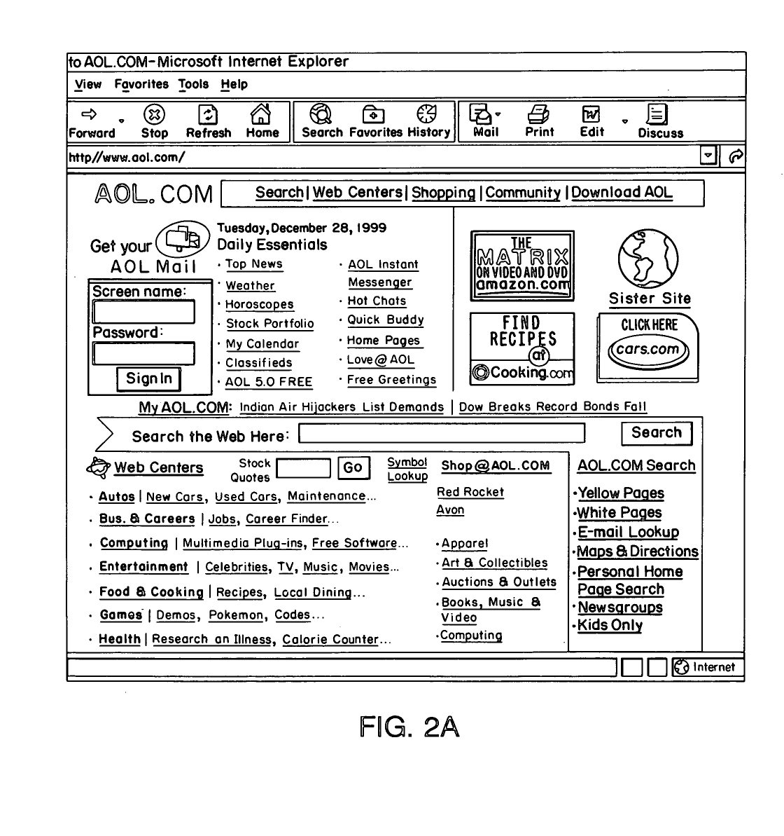

FIG. 1 is a block diagram of a system employing one embodiment of the invention. A wide-area networks (WAN) 10, such as the Internet, couple together a plurality of communication nodes. Some nodes, such as node 12, may be a standard prior art PC executing any conventional web browser. Alternatively, node 12 might be a set top box and television, or an Internet appliance, or a wireless device, such as a web-enabled cell phone. Additionally, there are server nodes connected to WAN 10, such as server node 16, which may be any conventional web server. Also coupled to WAN 10 are browser nodes 22 running a custom browser that facilitate access to information and services provided to the custom browser node 22. The custom browser node 22 as well as any browser nodes 12 are collectively referred to as client nodes. In another embodiment, the WAN may be a closed network that is not accessible via the Internet in order to maintain an increased level of control on content and usage to minimize security and stability problems. In addition, a closed network allows for the control of content to exclude hate speech, pornography, violent images and similar content. In a further embodiment, the simplified system may be used on a local area network, or other type of network.

Content partners, such as content partner node 14 provide content in a specified format that facilitates its use by the client nodes 12, 22. In one embodiment, when a user accesses a content partner home page, they have the option of linking to a sister site. As used herein, “sister site” is deemed to mean a site that provides for navigation of the site using a simplified navigation system, such as matrix navigation described in more detail below. In one embodiment, the sister site is traditional HTML pages converted to a matrix format to permit matrix navigation. This conversion may be done using an XML transcoding or any other suitable language.

Content partners may maintain a database of sister site web pages corresponding to the pages in the general use site. Alternatively, content partners may provide a facility for converting web pages on the fly to the sister site format. Content partners may also provide for segmentation of the base HTML web pages and/or the matrix pages. A segmentation may be performed in a number of ways. The page may be divided up based on content or area. The net result, in any case, is that the web page is divided into regions which are not necessarily, but may be, of equal size. The individual regions may be brought into focus independently. By “brought into focus,” the concept of focus in this context is analogous to the front window in a windowing system. The focus region is deemed active and subject to client manipulation. In the context of a matrix page, one suitable segmentation is by cell, e.g., each cell corresponds to a region that may be independently brought into focus. The borders of the regions may or may not be visible on the web pages displayed. This segmentation facilitates tab, scroll, and zoom features described in more detail below. Alternatively, segmentation may be performed as part of a custom browser on custom browser nodes or may be instantiated as a hardware or firmware solution within, for example, the set top box.

In another embodiment, a content partner or set of content partners may produce the content of their websites or new content in a format for use with the simplified navigation system. This content may be generated in the form of HTML, XML or similar scripting of description language based documents. This content may closely mirror data from a sister site, it may contain additional material, it may contain less material or the content may be specifically for use with the simplified navigation system. Content prepared for use with the simplified navigation system may be used in any situation where content produced by the conversion process is used. Content may be derived from any source for display on a television, personal computer, wireless or cellular device or similar device. Content may be prepared according to a template format by a content provider. Content may reside in a central server or be distributed across a network of computers. In one embodiment, the navigation system provider may also provide a template to be accessed by content providers for providing the content to the navigation system provider. The template may be downloadable or accessible through a browser or through the simplified navigation system.

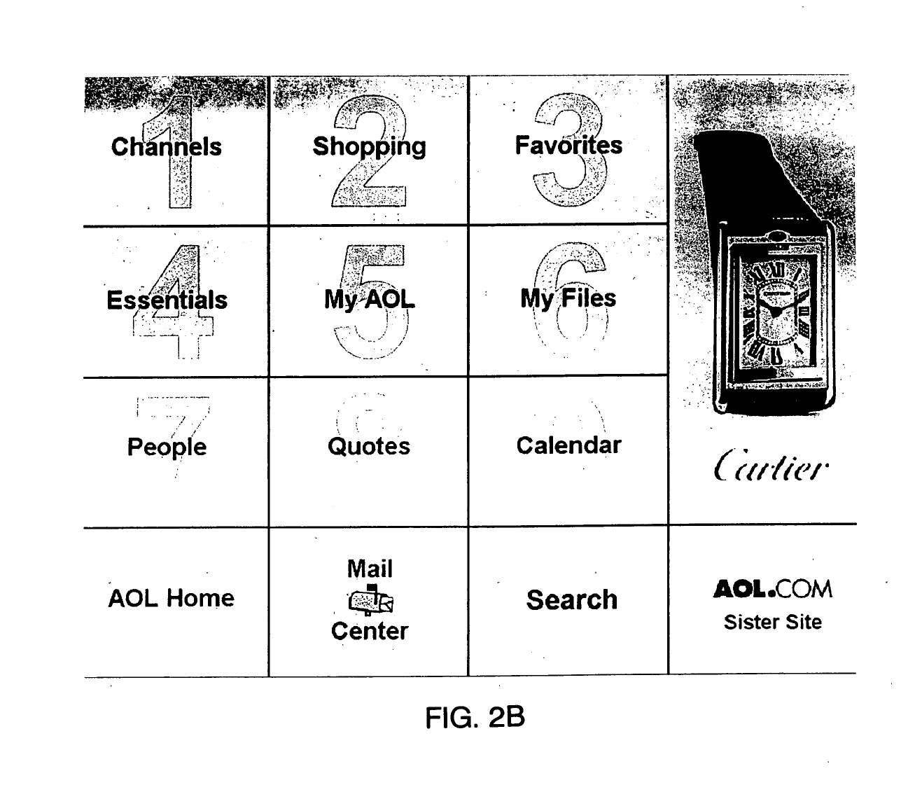

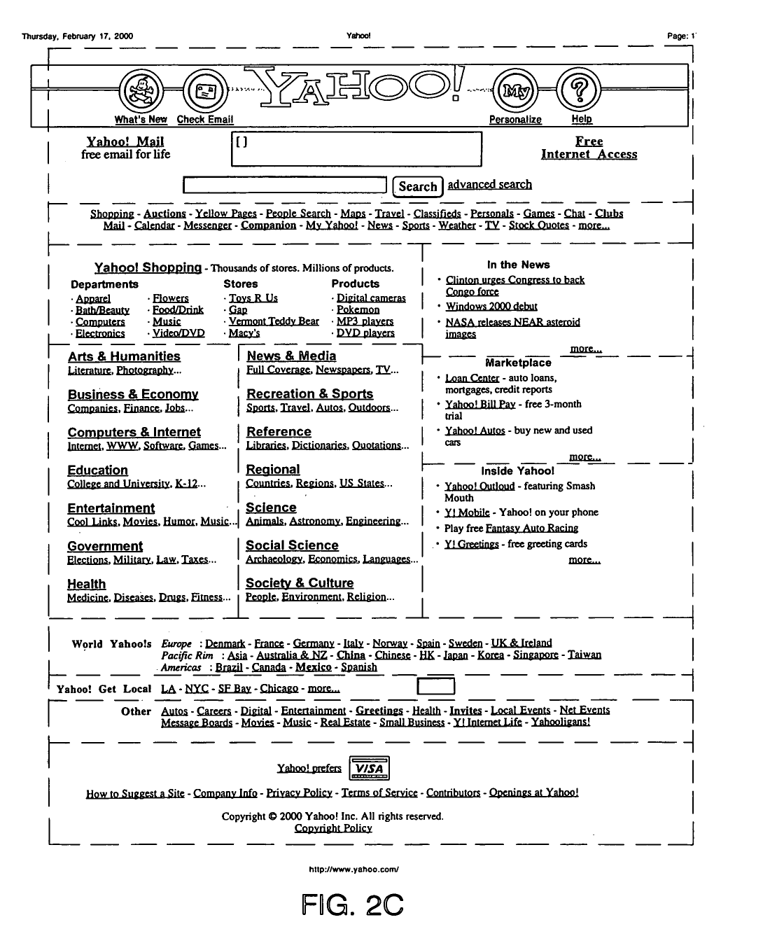

FIG. 2a is an exemplary web page having a sister site link. By actuating the link, the client begins receiving matrix pages as described in more detail below. FIG. 2b shows an example first matrix page reached by activating the sister site link in FIG. 2a. FIG. 2c is a web page having irregular segmentation. Through segmentation, the page is divided into regions. Individual regions may then be brought into focus permitting simplified navigation, viewing, and manipulation of the data within that region.

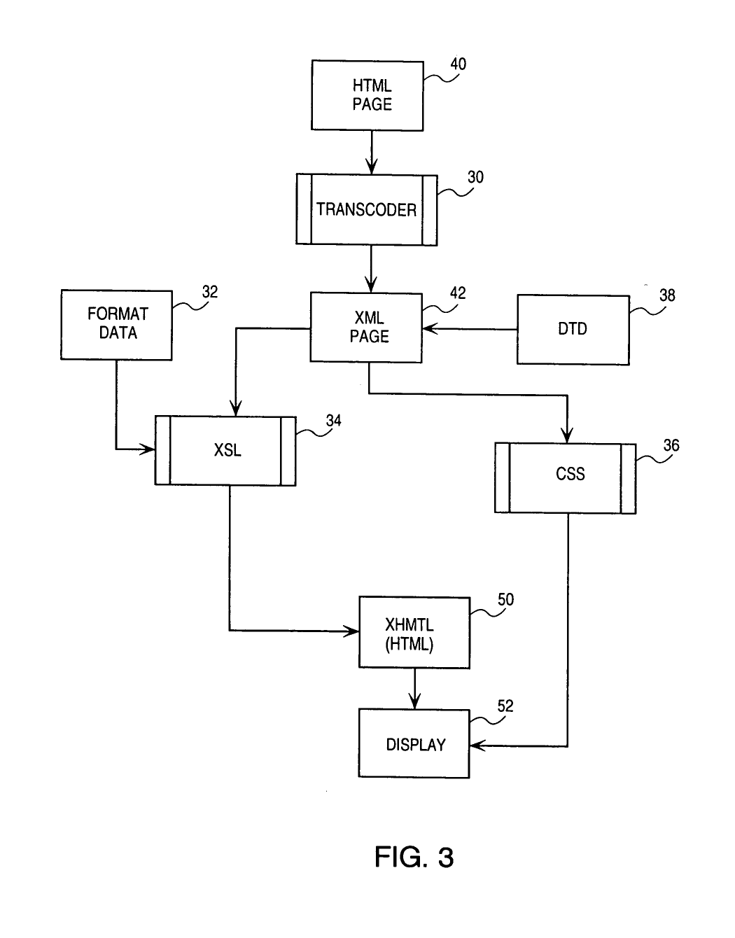

FIG. 3 is a flow diagram of conversion of standard HTML pages to a sister site format in one embodiment of the invention. A hypertext markup language (HTML) page 40 is transcoded by a transcoder 30 to yield, for example, an XML page 42 to which a document type definition (DTD) 38 is applied. The DTD 38 specifies the rules for the structure of the resulting XML document. The XML page is then reformatted using extensible style language (XSL) 34 to corresponding format data 32. XSL is not currently supported by all standard browsers. Thus, after formatting, the XML document is translated to an extensible hypertext markup language (XHTML) document for subsequent display by a client side browser on display 52. Alternatively, the XML page may have a cascading style sheet (CSS) applied to achieve the desired format. One advantage of the CSS is that it is supported by standard browsers. After application of the CSS, the resulting formatted page can be displayed by the client browser on display 52.

The above-described conversion may be done by a content partner in advance of request for pages or may be done on the fly responsive to requests for pages. The determination of which to do involves a trade off between latency in providing requested pages and storage space required to store the additional pages. Some on the fly conversion is desirable in the event that a user attempts to access a web site that has not previously been converted. It is also within the scope and contemplation of providing for conversion on the client side.

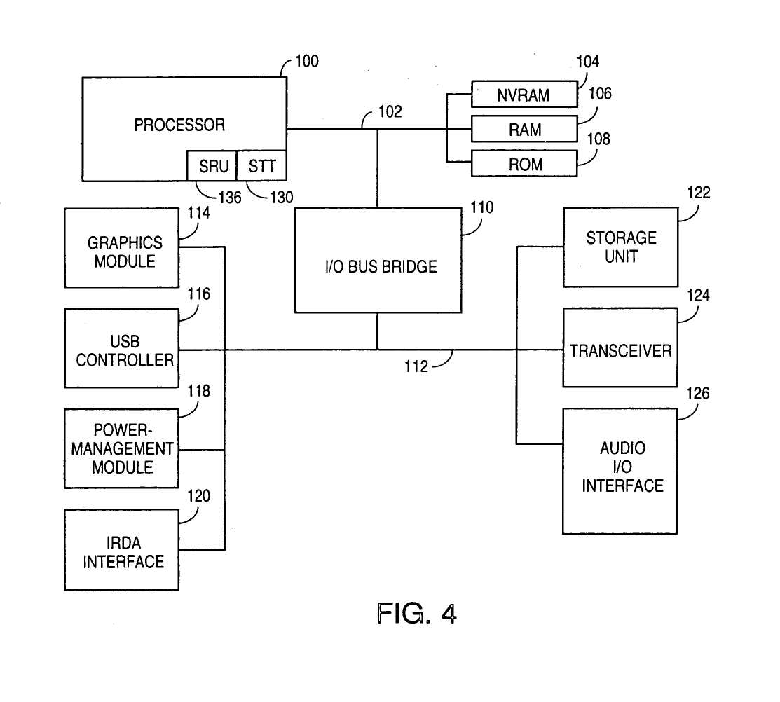

FIG. 4 is a block diagram of a client hardware architecture of one embodiment of the invention. A processor 100 is coupled to various memory units and an I/O bus bridge 110 by a local bus 102. Among the expected memory units are random access memory (RAM) 106, which may be any standard RAM, including standard dynamic random access memory (DRAM), and may be symmetric or asymmetric. Also coupled to bus 102 is a read-only memory (ROM) unit 108. The ROM will typically include the boot code for the processor 100. A non-volatile RAM (NVRAM) unit 104 is also coupled to the bus.

The I/O bus bridge 110 is coupled to the local bus 102 and bridges to the I/O bus 112. A number of units may reside on the I/O bus, including a graphics module 114 that couples to a display (not shown), a universal serial bus (USB) controller that may couple the system to any number of additional USB devices. Common USB devices include keyboards, mice, cameras, scanners, printers, and other peripheral components and input/output devices. Also coupled to the I/O bus may be power management module 118, which may be coupled to the power switch and may include conventional power conservation protocols, ensuring the processor 100 is permitted to orderly conclude its current operation before changing power states.

An infrared data association (IrDA) interface 120 permits the terminal to be coupled to hand-held devices, if desired. In some embodiments, a keyboard may be coupled by an Ir link. Storage unit 122, which may, for example, be a flash memory unit, is used for long-term storage of data or files. A transceiver 124 is used to permit the processor to communicate with the hub, whether it be a point-to-point link or across a network. The transceiver 124 may be, but is not limited to, an ethernet transceiver, a modem, digital subscriber line (DSL) or cable modem. It is expected that the processor 100 will communicate through the transceiver 124 to the server using transmission control protocol/internet protocol (TCP/IP). Encryption and compression within the terminal may be handled by conventional hardware or software solutions.

Audio I/O interface 126 may include an internal microphone and speaker which permits audio input and output. This is particularly useful in the context of voice e-mail or voice over IP communications. Additionally, some embodiments of the invention will include speech to text (STT) capability 130 and speech recognition (SR) capability 136. Various embodiments may implement these capabilities as hardware or software or a combination of both. In embodiments having SR capability, for simplicity of use, it is desirable to use one of the multiple user SR packages available today and expected to improve in the future, as these packages avoid the necessity of “training” the system. This permits recognition of content of speech and conversion to text.

For purposes of reduced cost, it may be desirable to use a particularly simple speech recognition package, recognizing only, for example, numbers and letters. A suitable speech recognition package will permit a user to navigate the network as subsequently described using voice commands and composed e-mails in a hands-free manner. Such an embodiment has the additional advantage that it enables Internet access to the physically challenged. In some embodiments, SR 136 is present, but STT 130 is not. This may permit the processor to respond to voice commands but would not permit composition of e-mail, for example.

In one embodiment of the invention, the terminal has a notebook form factor with an integrated LCD display. In an alternative embodiment, the form factor is a set-top box, which relies on an external display, such as a television or external monitor. In either case, a standard QWERTY keyboard could be used. In the set top box embodiment, a wireless keyboard or remote is desirable.

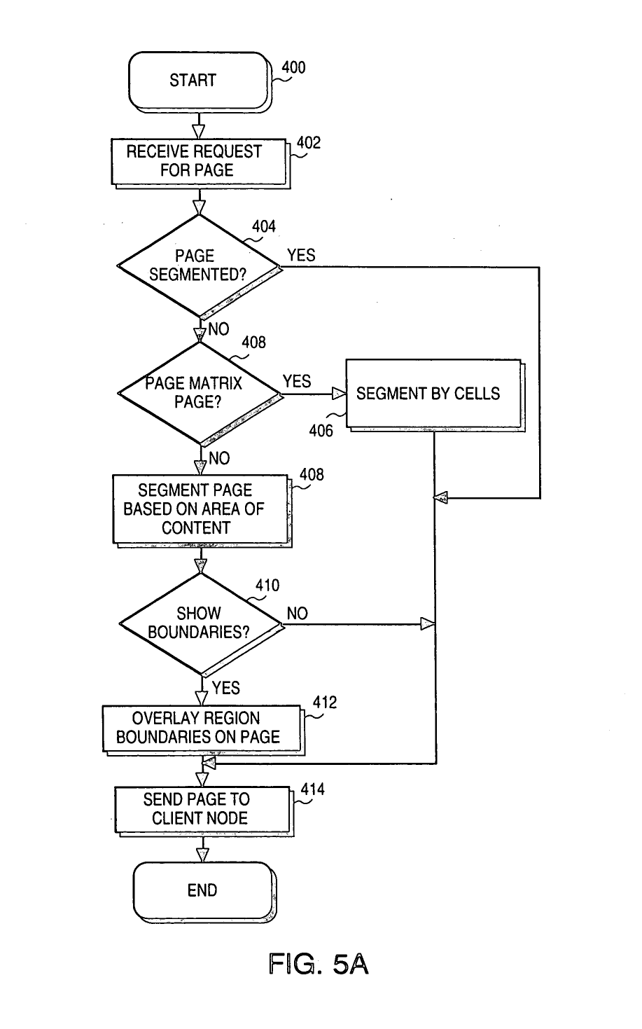

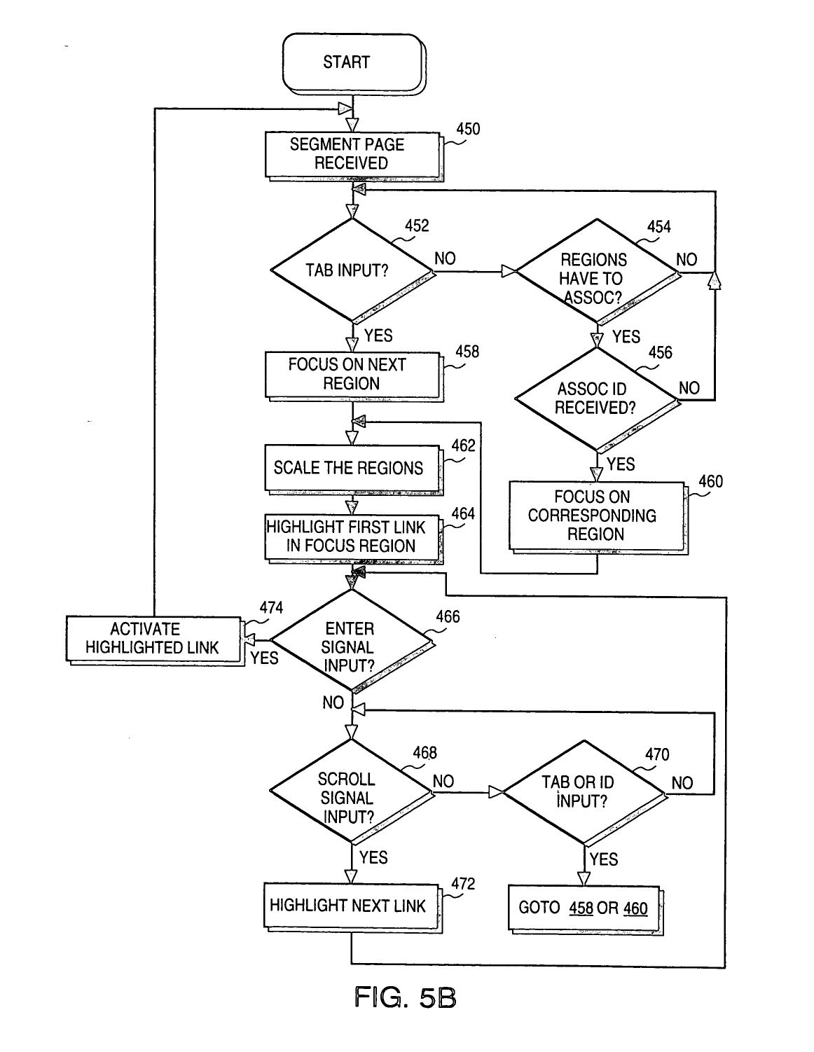

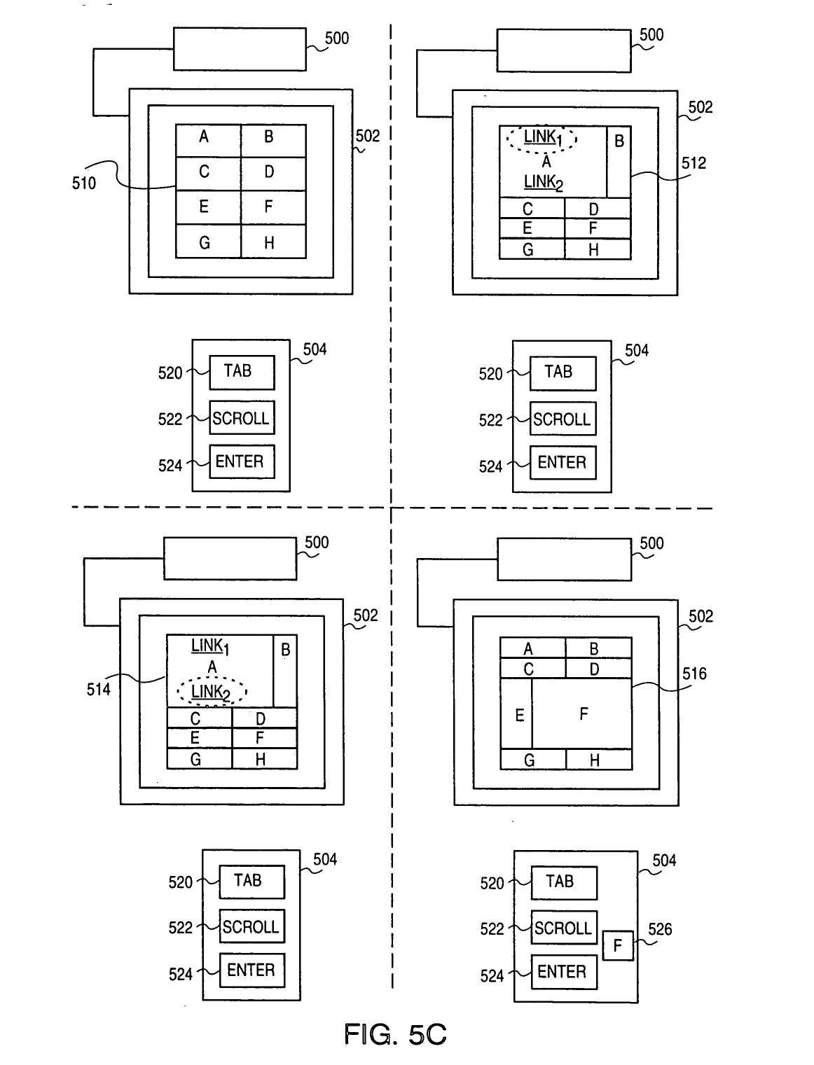

FIG. 5a is a flow diagram of server side segmentation in one embodiment of the invention. A request for a page is received at functional block 400. A determination is made at decision block 402 whether the requested page has been segmented. If the page has not been segmented, a determination is made at decision block 404 whether the requested page is a matrix page. If the requested page is a matrix page, at functional block 406, the cells of the matrix are each defined to be a region, thereby completing the segmentation. If the page is not a matrix page, the page is segmented either based on area or content. By “segmentation,” it is meant that the page is divided into a plurality of regions. The regions may contain one or more links and/or some amount of content. This segmentation facilitates usability as discussed in more detail below. Once segmentation is complete, at functional block 408, a determination is made if the boundaries of the regions should be shown on the displayed page at decision block 410. If the boundaries are to be shown, the boundaries are overlayed on the page at functional block 412 after the overlay, or if no boundaries are to be shown, the page is sent to the client node at functional block 414.

FIG. 5b is a flow diagram of client side manipulation of a segmented page in one embodiment of the invention. At functional block 450, a segmented page is received at a client node. A determination is made at decision block 452 if a tab input has been received. As used herein, a tab input is any input which brings about the functionality of moving the focus from one region to another adjacent region. If no tab input has been received, a determination is made at decision block 454 if the regions have identifying symbols associated therewith. Particularly in the case of matrix pages, the different cells typically have associated therewith either an alphanumeric character or some symbol such as an asterisk or other punctuation mark to identify the cell. If there are identifications associated with the regions, a determination is made at decision block 456 if such an identification has been received as an input on the client node. If the identification has been received, the corresponding region is brought into focus. The focus region is active, and in some embodiments, the corresponding region is zoomed to increase its size relative to the inactive regions at functional block 460. If no identifications are associated with the region or no identification is received, the client waits for a tab input at decision block 452.

If a tab input is received, the next region is brought into focus. If no region is currently in focus, a first region, e.g., the uppermost leftmost region, will be brought into focus at functional block 458. At functional block 462, the regions are scaled so that the in focus region is enlarged relative to the regions which are not in focus. This is particularly desirable for web browsing in a television context where distance from the set may make reading the unscaled page difficult or impossible. Thus, by scaling region by region, readability within the region can be enhanced to permit use and browsing from a distance.

At functional block 464, a first link in the focus region is highlighted. As used herein, “highlighted” means made active such that a subsequent input, such as a predefined key press activates the link. Highlighting in the link context is analogous to focus in the region context. Highlighting may, but need not include, changing the link's appearance in any manner on the display such as, for example, changing size, color, shading, etc. A determination is made at decision block 466 if an enter signal has been received. However, if no enter signal has been received, a determination is made at decision block 468 if a scroll signal has been input at the client node. If a scroll signal has been input, a next link is highlighted at functional block 472. If an enter signal is received at functional block 466, a then highlighted link is activated at functional block 474 and a next segmented page is received, and the process begins again. Alternatively, if no scroll signal input is received at decision block 468, a determination is made at decision block 470 whether a tab or identification input has occurred. If it has, the system continues processing at blocks 458 or 460, respectively.

FIG. 5c is a diagram showing a system implementing the tab, scroll, and zoom features of one embodiment of the invention. A set top box 500 is coupled to a television monitor 502 and is responsive to remote control 504. Remote control 504 may be a custom remote control, a wireless keyboard, or even a standard universal remote control. Remote control 504 may be equipped with a microphone for accepting voice commands or may merely provide push button inputs. In frame one, television 502 is displaying a web page 510 that has been segmented into eight equally dimensioned regions A-H. Remote control 504 includes a tab function 520, a scroll function 522, and an enter function 524. Responsive to actuation of the tab function, region A is brought into focus, as shown in the second frame. Link one is highlighted and A is enlarged, while the remaining regions are scaled so that A is much larger relative to the other regions, thereby accomplishing a zoom function and improving readability of the information contained in region A. This is shown as web page 512. If, when A is in focus, the user actuates scroll function 522, a second link in region A is highlighted as shown on page 514. In one embodiment, scrolling within the focus region does not effect the size or representation of the non-focus regions. In the event that, at web page 512 or web page 514, the enter function 524 is actuated, link₁ or link₂ would be traversed, respectively. If the segments are actually associated with their alphanumeric designator, and that remote control 504 has alphanumeric keys, for example, letter key F 526, web page 516 shows a web page that would be reached from web page 510, 512, or 514 responsive to actuation of the F key. In web page 516, the F region is in focus, and the remaining regions are scaled to be much smaller than the F region.

These are merely illustrative examples of the tab, scroll, and zoom features of one embodiment of the invention. While the shown embodiment tiles the regions, it is within the scope and contemplation of the invention to overlay the focus region on one or more of the other regions. It is also within the scope of the invention to permit a user to increase the zoom of the focus region to exceed the physical space. In such case, scrolling within the region may be required to view the entire contents of the region. Such scrolling need not effect the display of the non-focused regions.

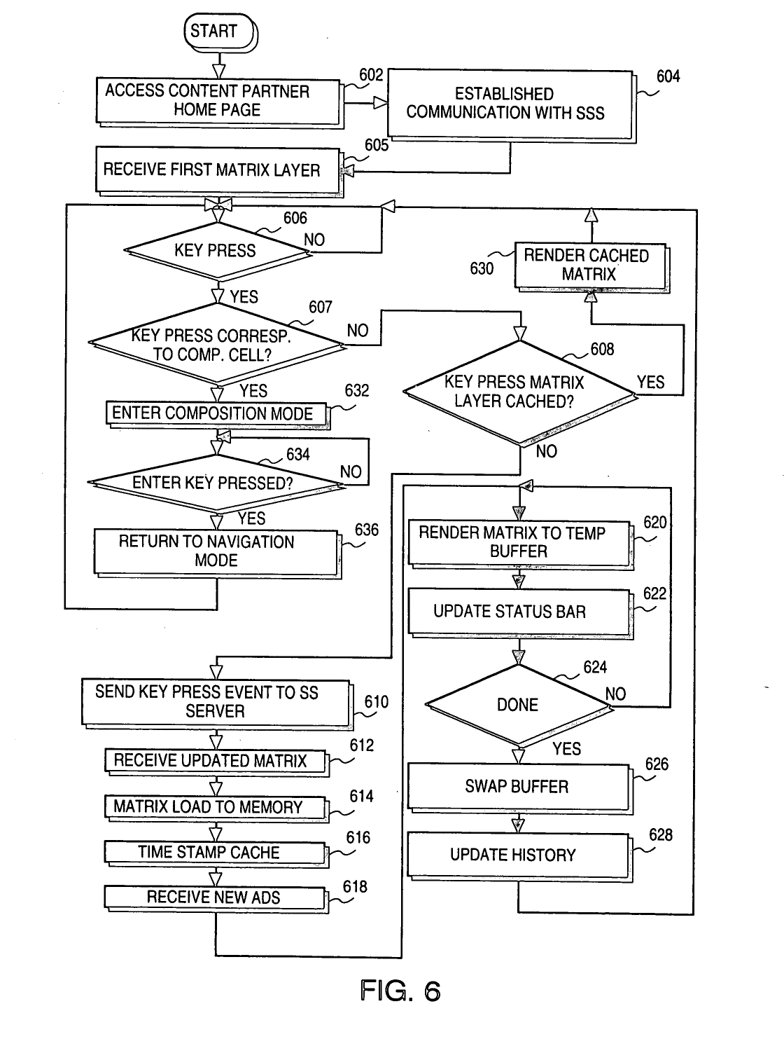

FIG. 6 is a flow chart of operations of the navigation system of one embodiment of the invention in a custom terminal custom browser node. Upon power-up at functional block 602, a content partners home page is accessed. In some embodiments, it may be possible to bypass access of the home page and go directly to the sister site home page. At functional block 604, a node establishes communication with a sister site server (SSS). At functional block 605, a first matrix layer is received from the SSS. At decision block 606, the node waits for a keypress. If at decision block 606, a determination is made that a key has been pressed, a determination is made at decision block 607 whether the keypress corresponds to a composition cell. A composition cell is deemed to be a cell in the navigation matrix which permits a user to enter additional data. For example, a search cell or e.g., a purchase order form or an e-mail may have one or more composition cells. If the cell is a composition cell, the system enters composition mode at functional block 632. In composition mode, the digits of the keypad represent the digits themselves, rather than navigation options. The cursor will also appear in the composition field of the composition cell. At decision block 634, a determination is made if the enter key has been pressed. The enter key is defined in one embodiment of the invention to signify the end of a composition. Thus, if the enter key has not been pressed, the system remains in composition mode. However, if at decision block 634, the enter key has been pressed, the system returns to navigation mode at functional block 636. It is also within the scope and contemplation to define other keys to instigate return to the navigation mode.

If a keypress is received and not found to correspond to a composition cell at decision block 607, a determination is made at decision block 608 whether the matrix layer corresponding to the keypress exists within the cache. In this connection, it is determined whether a representation of that matrix layer, even if in the cache, is stale and therefore needs to be freshly downloaded. If the data is stale or not present in the cache at all, the keypress event is sent to the SSS. In one embodiment, the entire navigation path, including the keypress event, is sent with each keypress. When the navigation path is sent with each keypress event, the SSS is able to identify the requested matrix layer rapidly on the fly.

Subsequently, at functional block 612, the client node receives the updated matrix layer corresponding to the keypress event. That matrix layer is loaded to the memory at functional block 614 and the cache is time-stamped at functional block 616. At functional block 618, new ads may be received from the SSS. Notably, the receipt of the ads is asynchronous with the matrix layer receipt and may occur at any time without being prompted by a keypress event. At functional block 620, the incoming matrix layer is rendered to a temporary buffer by using a double-buffering technique. The actual rendering is transparent to the user. At functional block 622, the status bar for the load is updated to indicate the percent complete of the matrix layer rendering. At functional block 624, a determination is made if the rendering is complete. If it is not, the buffer continues to render and the status bar continues to update. By regularly updating the status bar, the user is not left wondering if the device is working. This is expected to limit the frustration experienced by many new users during the wait while matrix layers are rendered. If the rendering is complete, the temporary buffer is swapped with the frame buffer and the new matrix layer is displayed at functional block 626. Then at functional block 628, the history of the navigation path is updated to reflect the new matrix layer. The system then returns to await a next keypress to indicate further navigation. By iteratively pressing appropriate keys, a user may navigate to any desired depth up to a maximum depth along any navigation path and obtain content relevant to the path navigated. If instead, the matrix layer was validly in the cache at decision block 608, the matrix layer is rendered from the cache at functional block 630 and the system awaits the next keypress.

“Maximum depth” as used herein applies on a cell by cell basis for primary navigation options. A maximum depth is reached for a cell in a navigation path when pressing a corresponding key will not take a user to a deeper matrix layer in the matrix. While content, as distinguished from the matrix layer and their cell headings, will be displayed once a maximum depth is reached, it is within the scope and contemplation of the invention to display some content in cells of an intermediate matrix layer, i.e. one that is not at the maximum depth.

“Primary navigation options” as used herein are those navigation options that necessarily change between successive matrix layers, changing from general to more specific with increases in depth in the matrix.

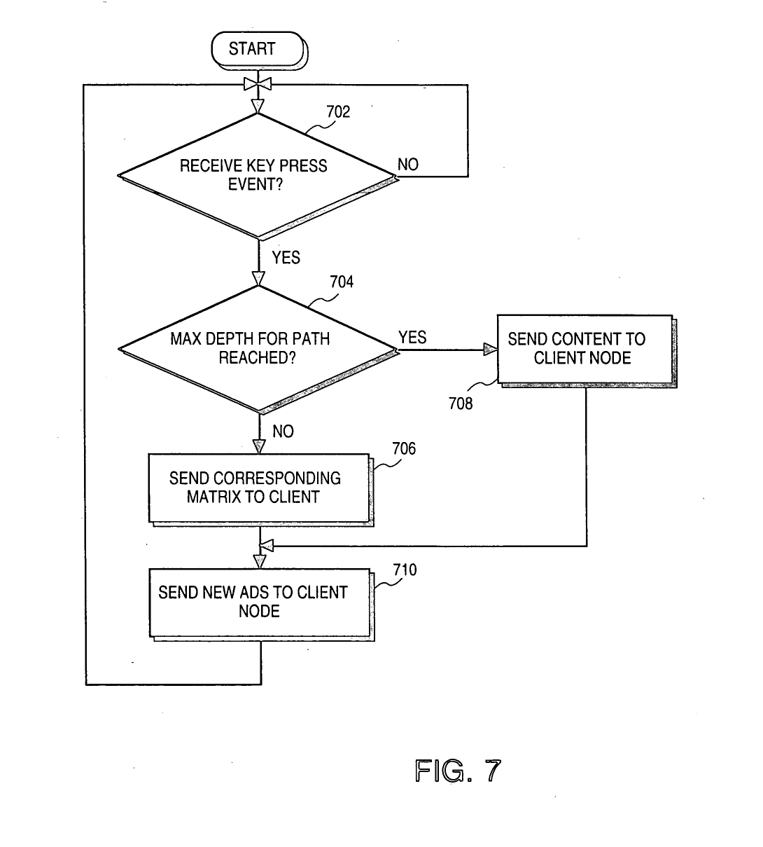

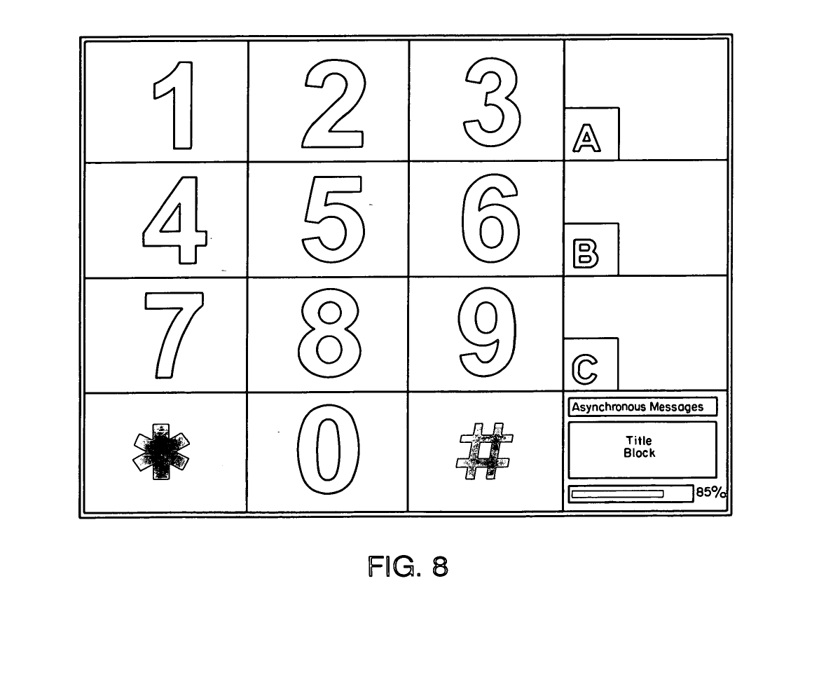

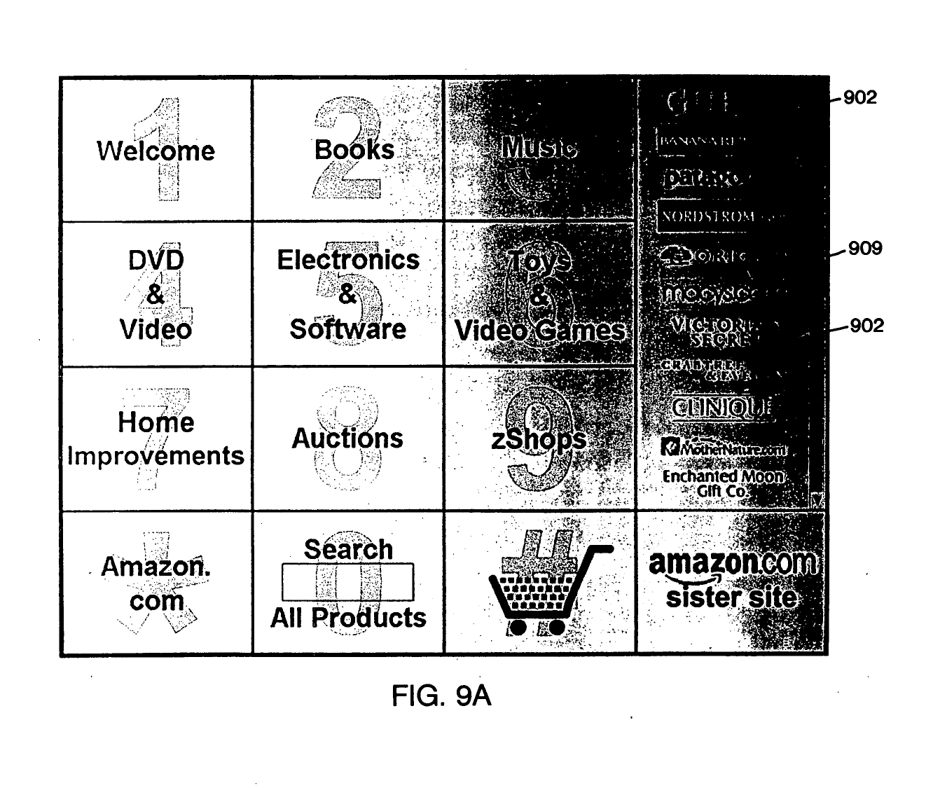

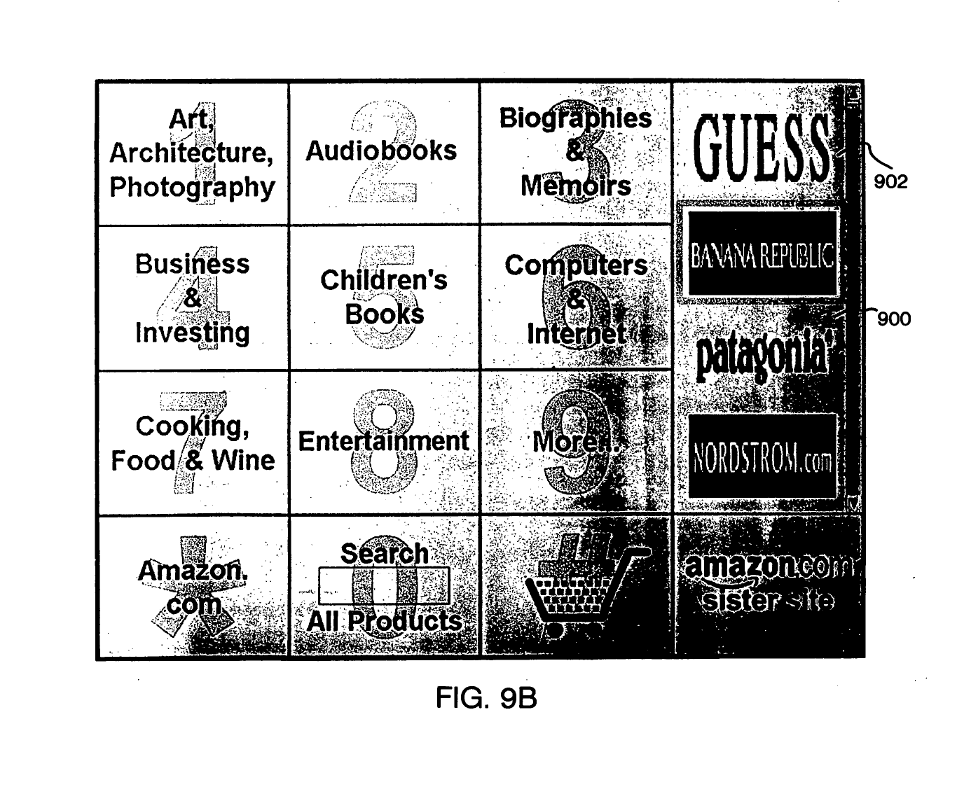

FIG. 7 is a flow diagram of operation of the sister site server of one embodiment of the invention. A determination is made if the keypress event has been received at decision block 702. If the keypress event has been received, a determination is made if the matrix has reached maximum depth at decision block 704. If the matrix has not reached the maximum depth, a matrix layer corresponding to the keypress is sent at functional block 706. Such matrix layers may or may not include content in cells with navigation choices. If the matrix has reached maximum depth for that navigation path, a content layer corresponding to the keypress event is sent to the client node at functional block 708. A content layer may or may not include matrix cells in addition to the content. New ads are sent to the client node at functional block 710. The system then awaits the next keypress event from a client node.

FIG. 8 is a diagram of the display of a graphical user interface of one embodiment of the invention. The screen is divided into a plurality of cells. In this embodiment, there are fifteen cells that represent navigation options and one messaging cell for displaying messages from the server, the progress or status bar, and a title block. The cells can further be subdivided between the digit keys 1-9 keys which, in this embodiment, represent the primary set of navigation options and the keys designated by letters A-C which represent secondary navigation options and *, 0, and # keys that may be additional navigation options or provide specialized functions. For example, the * key may return the user to the server home site, thereby leaving matrix navigation. The ABC cells will typically hold advertising, and selecting one of those cells will generate a matrix layer with primary navigation cells directed to that advertiser or the product line being advertised. While the interface is designed to be fully accessible with minimal key strokes from a key pad, it is also within the scope and contemplation of the invention to permit selection with a mouse or other pointer device.

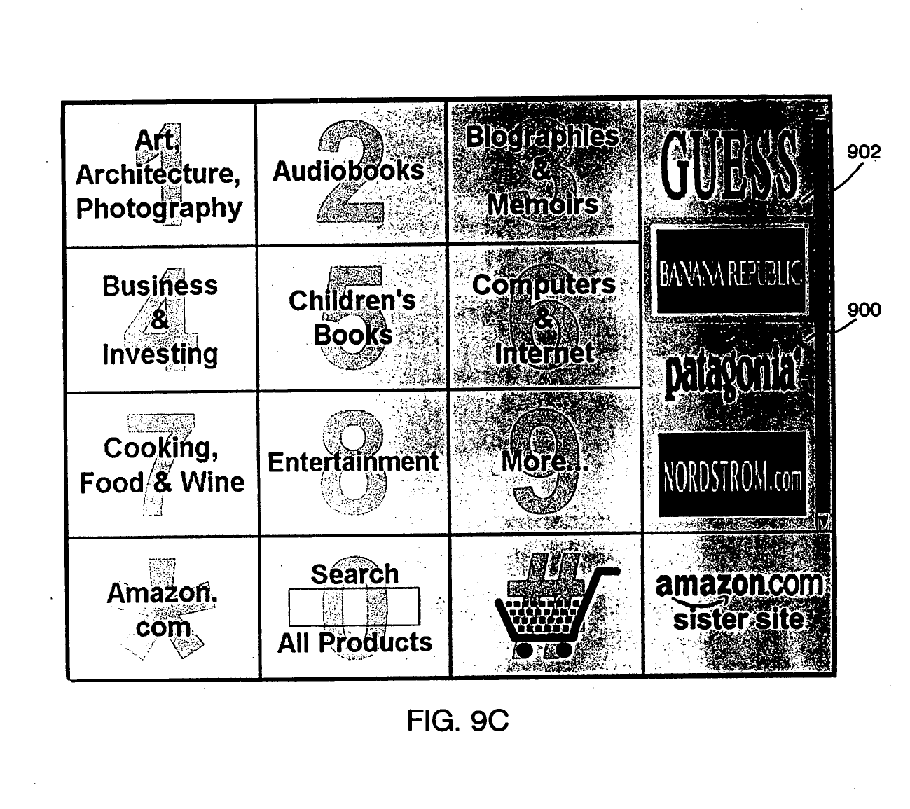

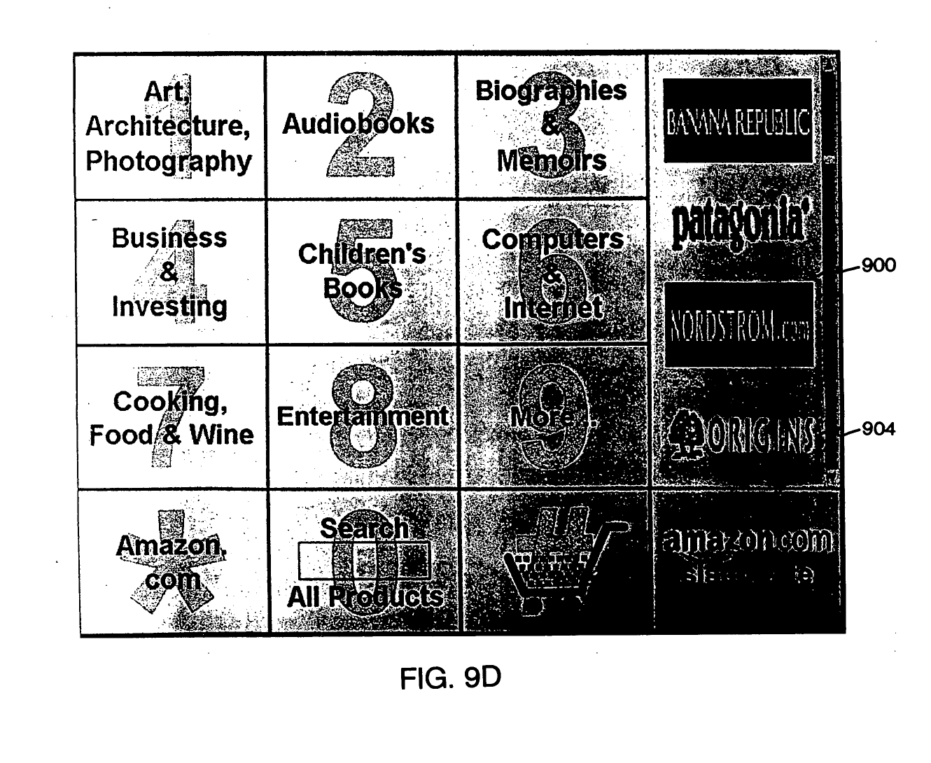

FIGS. 9a-d are example sister site matrix pages. In FIG. 9a, an advertising cell 900 is the focus region of the displayed image. Ten advertisements are displayed within the regions. The first advertisement 902 is highlighted. From this matrix page, the * returns a user to the amazon.com home page. The # reveals the contents of a user's shopping cart. In FIG. 9b, the contents of the focus window have been enlarged (zoomed) such that only four advertisements are displayed in ad cell 900. The no links/advertisements are highlighted. In FIG. 9c, advertisement 902 is again highlighted. This may occur, for example, by a user pressing a scroll key from FIG. 9b. In FIG. 9d, a user has pressed a scroll key several times from FIG. 9c. Thus, advertisement 902 has scrolled out of view and advertisement 904 is highlighted. While in this example, ten advertisements were present, the number of links within such a cell may be arbitrarily large. In the shown embodiment, scrolling through the links in the focus cell and scaling the focus cell content does not effect the user's view of the remaining cells.

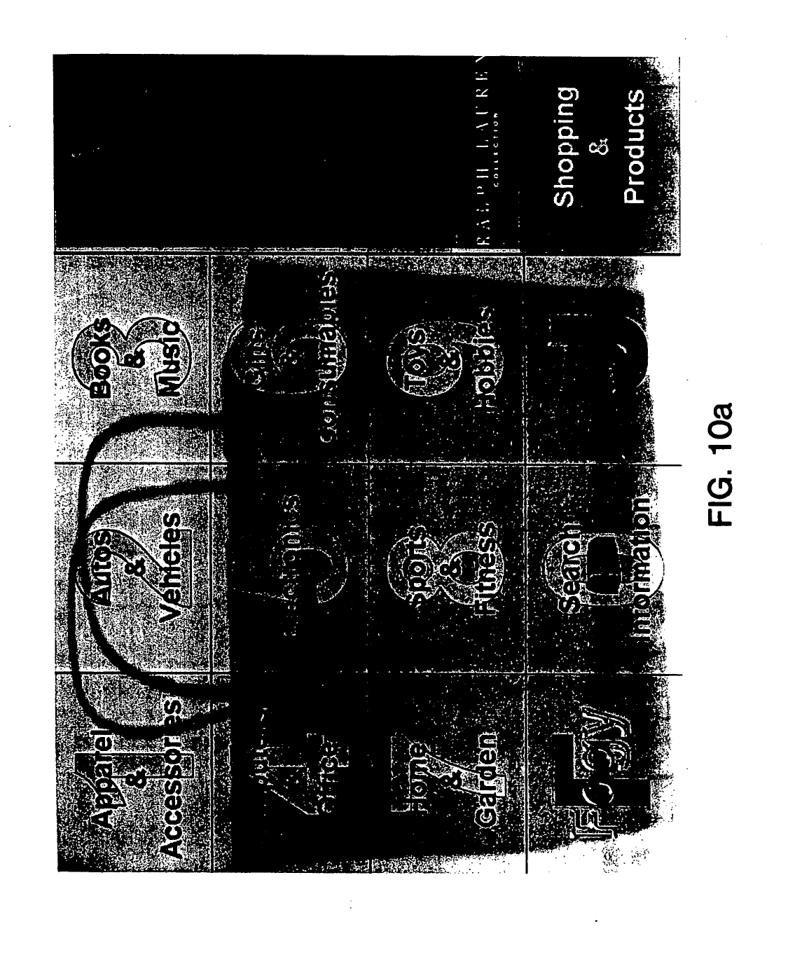

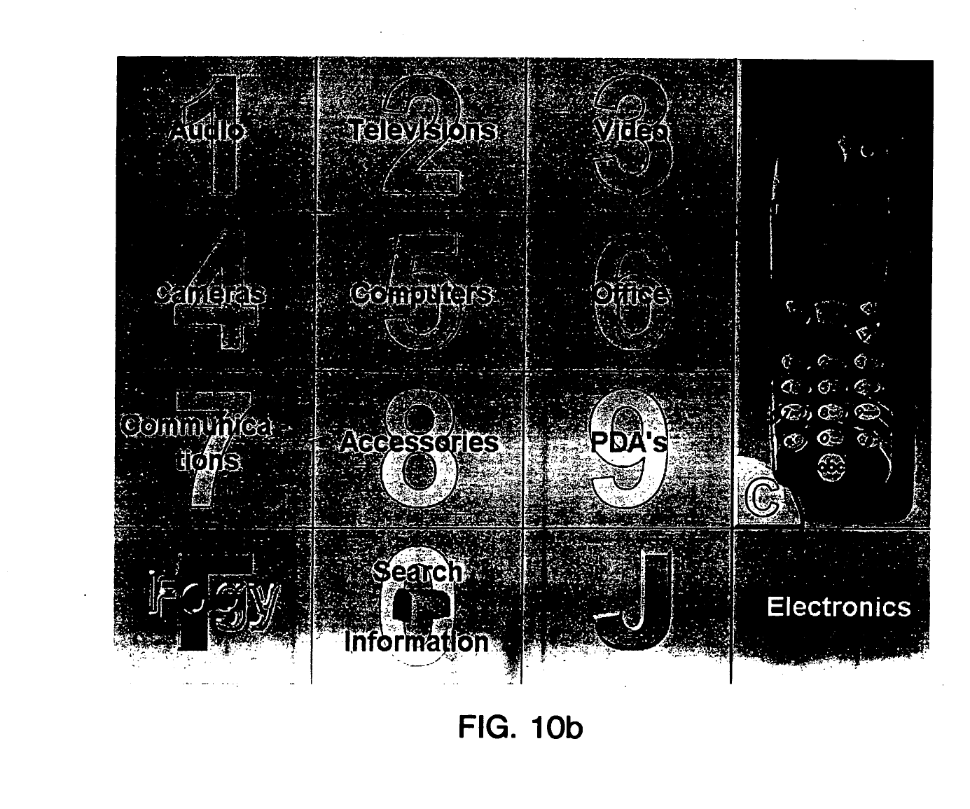

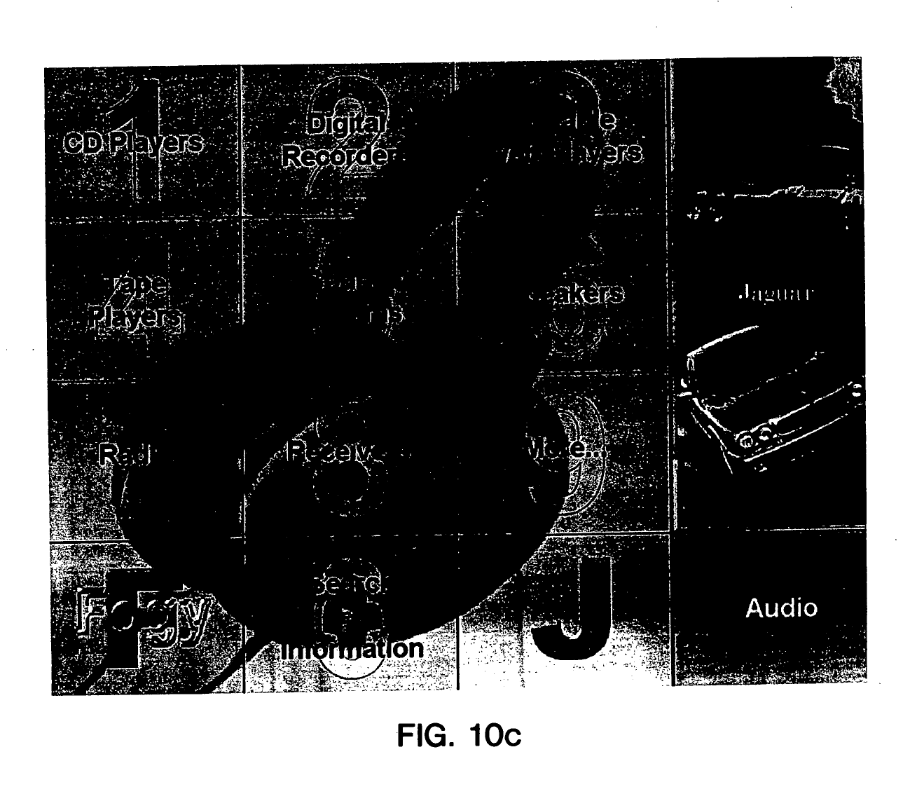

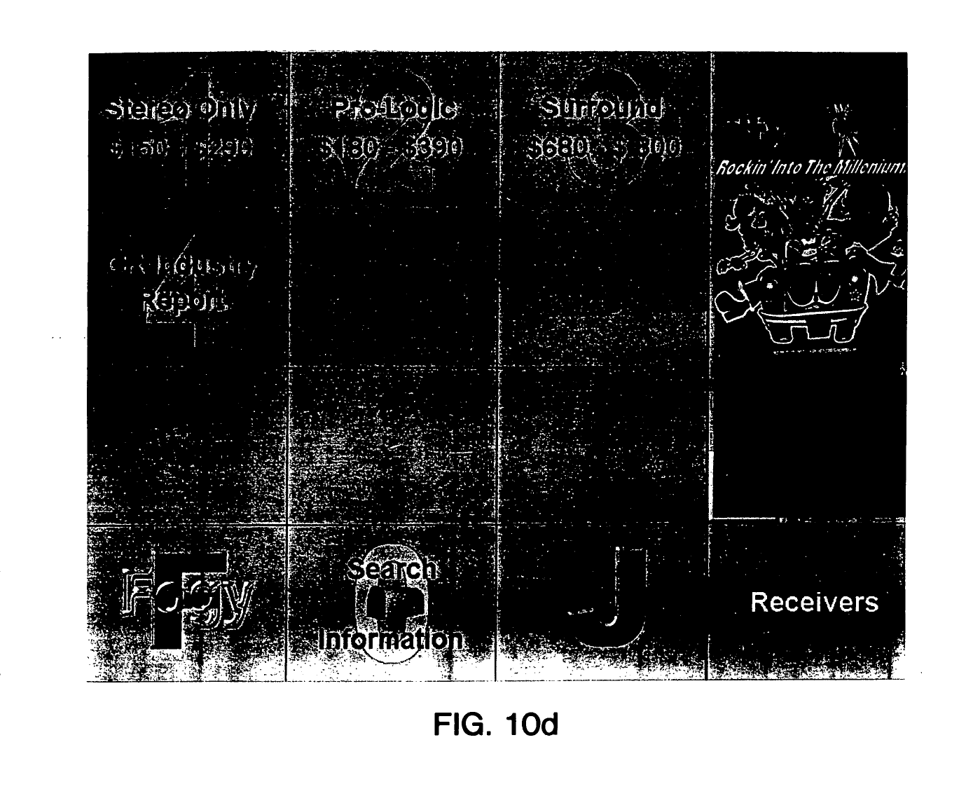

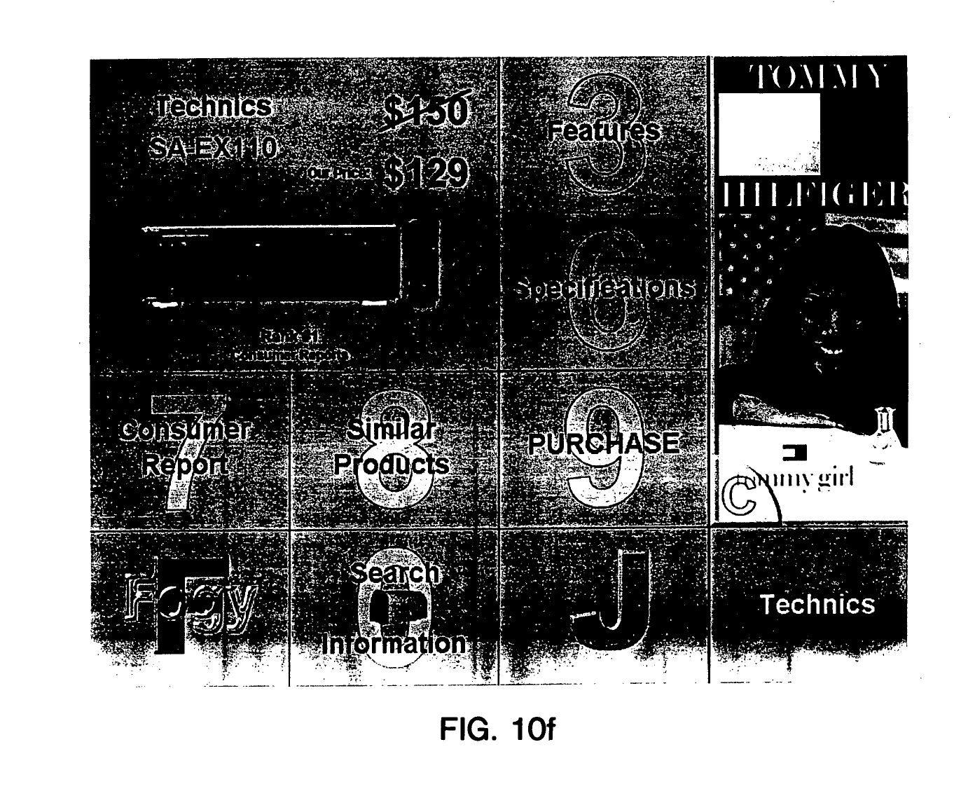

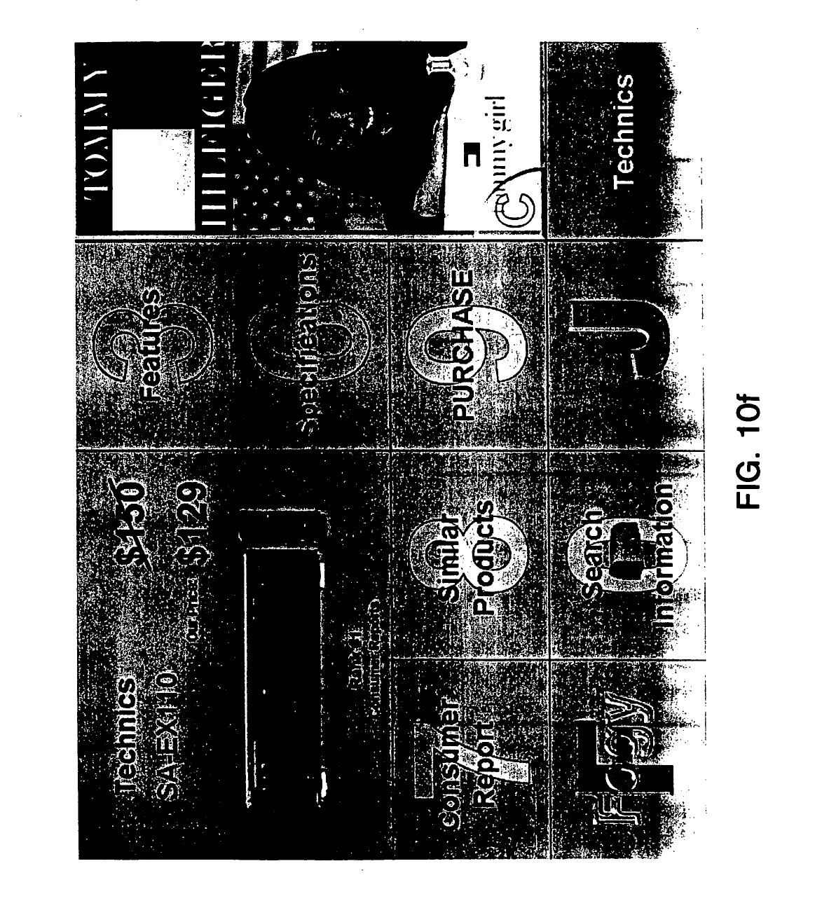

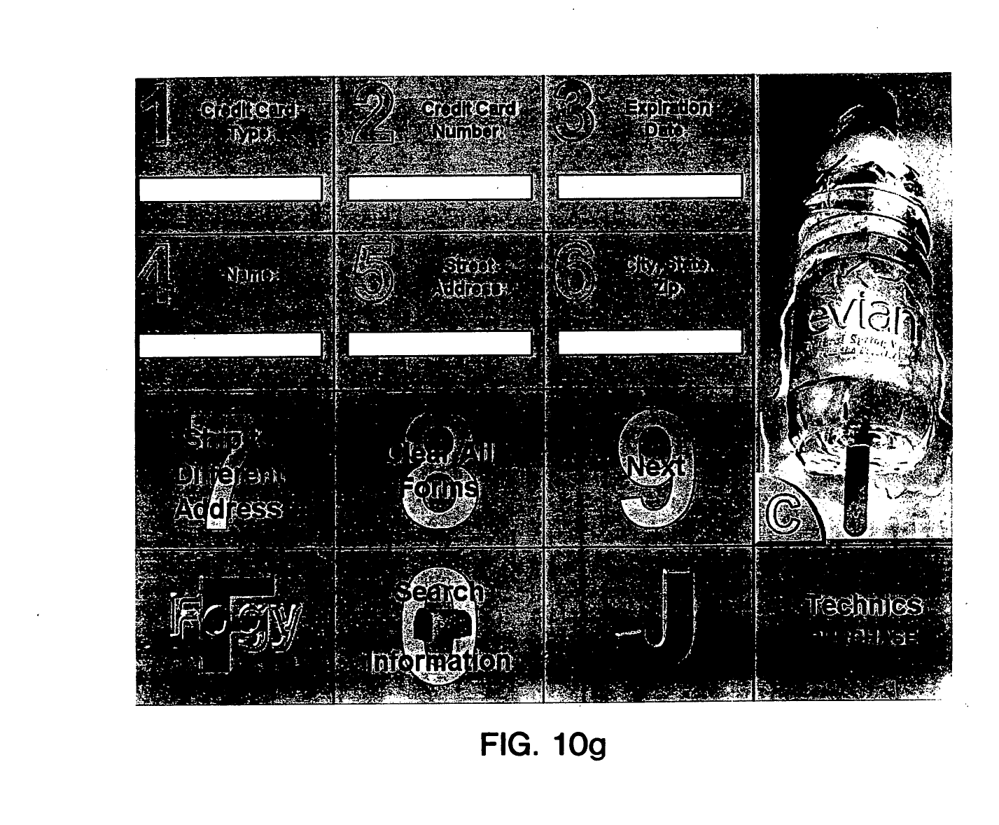

FIGS. 10a-g are a series of matrix layers displayed during an exemplary navigation using one embodiment of the invention. In this example, navigation begins at the Shopping and Products matrix layer and shown in FIG. 10a. A selection of 5 on the 10a matrix layer yields an Electronics matrix layer shown in FIG. 10b.

Selecting 1 on the keypad when the matrix layer of 10b is displayed yields the Audio matrix layer of FIG. 10c. By selecting an 8 on the keypad when 10c is displayed, the system displays a Receivers matrix layer of FIG. 10d, which breaks down receivers into price categories and also provides the option of navigating, in this embodiment, into Consumer Reports industry reports related to receivers. Notably, in FIG. 10d, the number of primary navigation options is reduced to 4. Thus, it is not necessary that all layers of the matrix have the same number of cells, nor is it required that all cells have the same size. A user can select Stereo Only by pressing 1 on the keypad, which yields a stereo only matrix layer shown in FIG. 10e.

In one embodiment of the invention, the products are ordered based on some ranking system, such as Consumer Reports. Thus, for example, in FIG. 10e, Technics received the highest ranking of receivers in the selected category from Consumer Reports. It is expected that for any particular product class, potential purchasers are likely to only be interested in the top several products within that class, not for example, the 15^{th} best receiver in the $150-$290 range. However, it is within the scope and contemplation of the invention to permit a “more” option which allows a user to get a set of the next most highly ranked products and possibly unranked products as well. It is expected that supplying product options in a user-friendly ranked order will encourage users to be more willing to conduct e-commerce.

By selecting a 1 on the keypad when matrix layer 10e is displayed, a user reaches the matrix layer of FIG. 10f, as well as reaching the maximum depth for that navigation path. Thus, pressing 1 on the keypad in response to matrix layer 10f does not move the user deeper into the multi-dimensional matrix, and content is displayed in cell 1 indicating the model, price, picture, and possibly other information about the Technics product. Cell 1 is also larger than the other cells.

Other navigation options are provided in additional matrix cells surrounding cell 1 and its content. The additional cells represent navigation paths that have not reached their maximum depth. For example, by pressing a 3, one would get to a features of the Technics product content layer. Such screen would display features of the Technics system. The various navigation paths typically have a maximum depth at which content is displayed. However, reaching the maximum depth of a particular navigation path does not indicate that another navigation path may not have yet a deeper matrix layer. For example, while the maximum depth of the navigation path corresponded to cell 1 has been reach in FIG. 10f, selecting a 9 on the keypad will move a user to a Technics purchase matrix layer, shown in FIG. 10g. By selecting digits on the keypad, a user can move between fields to fill out a purchase form which, as discussed above, is one example of a matrix layer including composition cells. In some embodiments, the form can be filled in using keyboard input. In other embodiments, the speech to text capabilities of the terminal will permit the user to fill out the electronic purchase form orally.

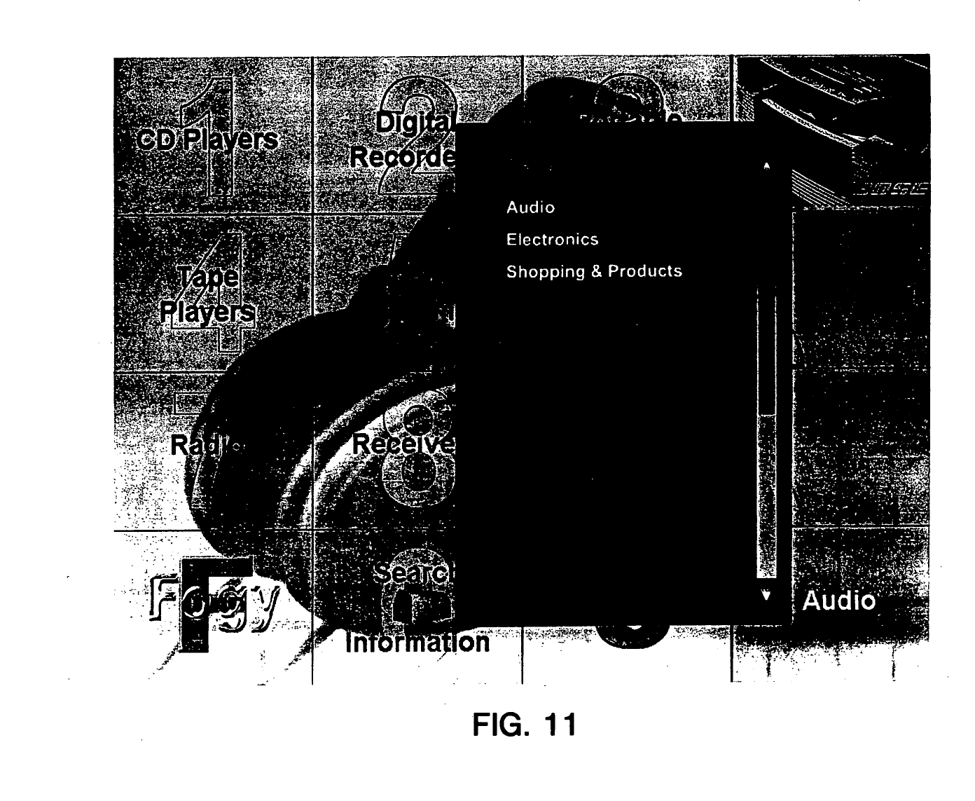

FIG. 11 shows a history window overlying a navigation matrix. The history window would appear if the history button on the keypad were actuated. By using the up/down arrow key on the keypad, the user may then select a prior matrix to jump to directly without moving backwards or forwards iteratively.

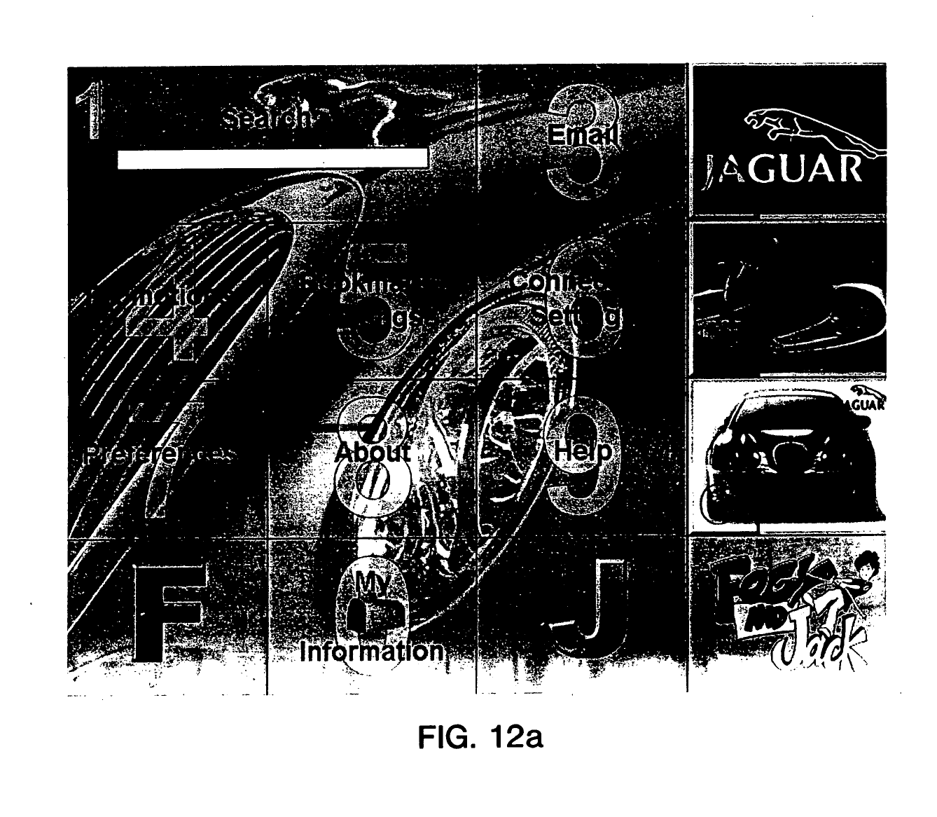

FIGS. 12a and b are an example matrix after a selection of 0 from the main menu screen, which allows one to conduct a search through cell 1. On this figure, advertisements for Jaguar appear in the ABC cells. In one embodiment of the invention, the ABC designation appears initially (as shown in FIG. 12a) when the screen is first refreshed and then fades away to reveal solely the advertisement in each of those cells (as shown in FIG. 12b). In this example, pressing an A on the keypad would take the user to a matrix reflecting company information about Jaguar. Pressing B would take the user to a matrix for the virtual showroom, and C would take the user to a purchase screen for the advertised item.

In some cases, the advertising cells are merged as a single cell showing a single advertisement and permitting navigation to only a single matrix layer therefrom. In one embodiment, the background can be an advertisement. This is also shown in FIGS. 12a and b. Significantly, the advertisement can be targeted by modifying the ad responsive to the apparent navigation path of the user. This leaves the potential of showing the user an advertisement for a product or service more likely to be of interest. For example, when a user selects Electronics in the example of FIGS. 10a-g, the next screen may have as background an advertisement, e.g. for Circuit City.

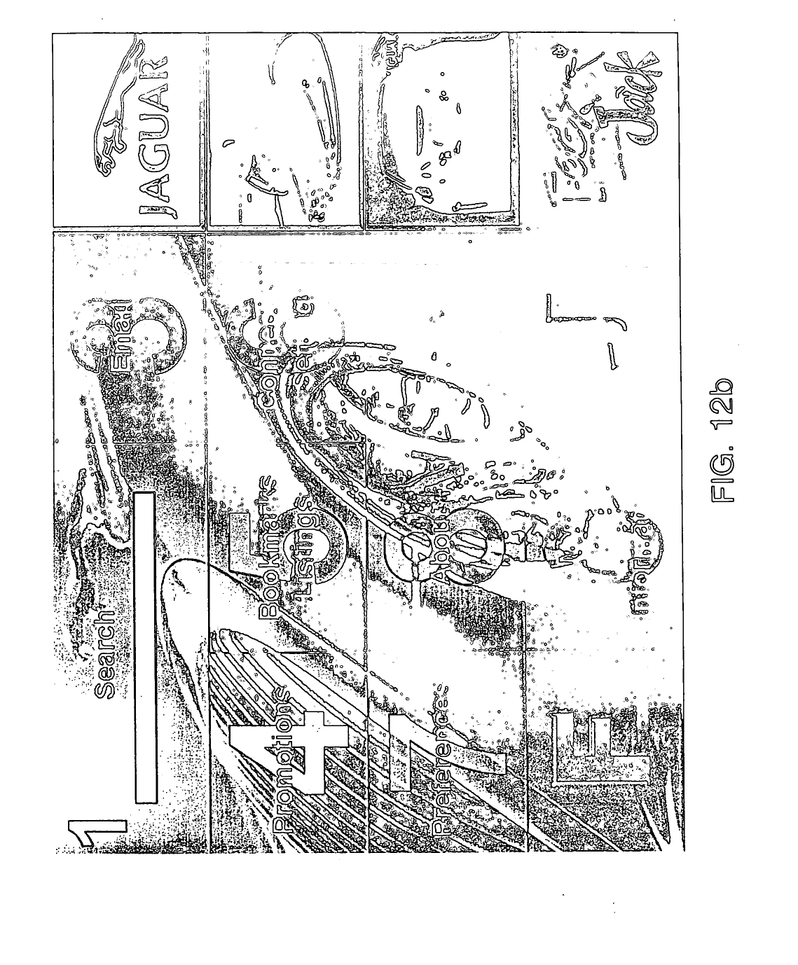

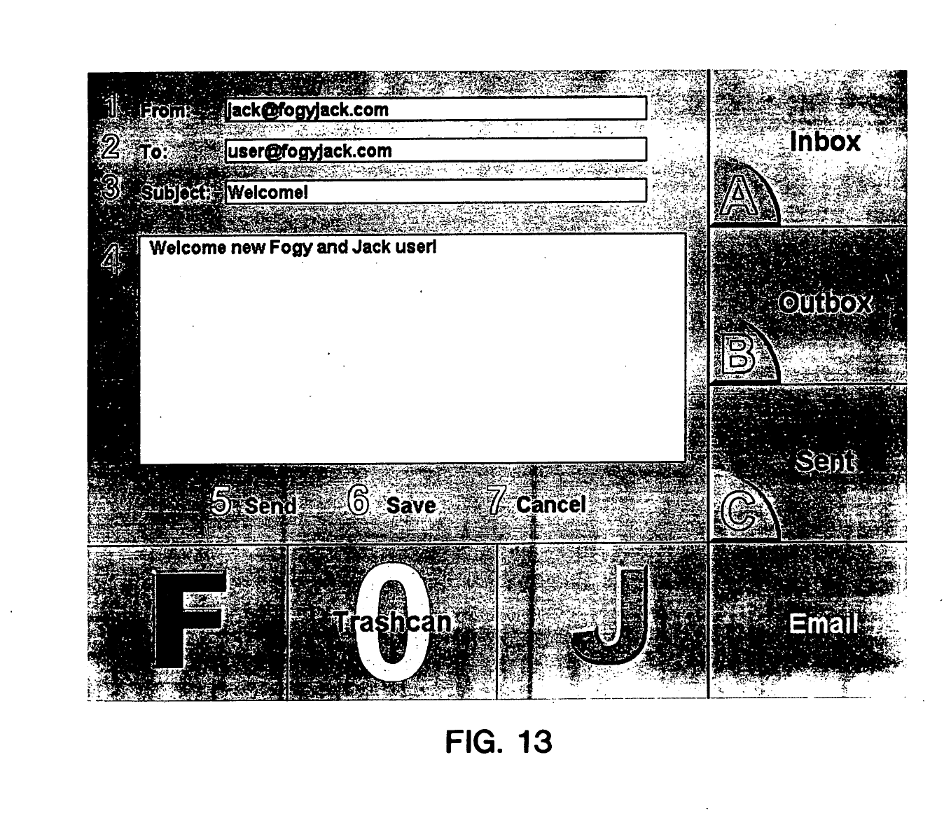

FIG. 13 shows the e-mail creation screen for one embodiment of the invention. This would be reached by pressing 3 on the keypad when the matrix layer of FIG. 9d is displayed. Again, all e-mail functions other than actually entering the text and the address can be performed using the simple interface with numerical digits and the letters ABC corresponding to inbox, the outbox, and the sent features of standard e-mail, respectively.

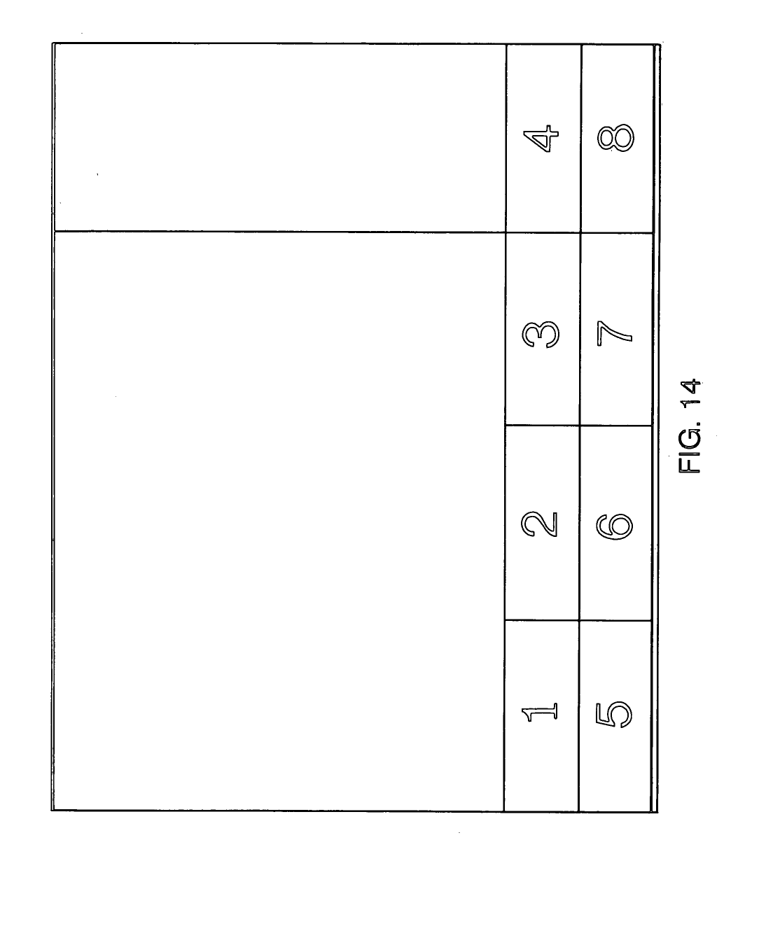

FIG. 14 shows an alternative matrix page of one embodiment of the invention. In this embodiment, the matrix occupies only a portion of the screen real estate. The remaining real estate may be occupied by content, a zoom of the focus cell, or advertising.

The simplified navigation system may be used for specific applications and systems. In one embodiment, the simplified navigation system is used as an interface for an interactive television shopping system. In this embodiment, the content from multiple providers may be interleaved to form a hierarchy of content. This interleaving of content organizes the shopping experience such that a user can easily browse the shopping system using the simplified navigation interface. Products and services may be grouped by sellers and categories in order to assist the user in finding a desired product or service. This system may utilize primary navigation options and allows a user to select categories, products, services, and sellers using a unique input. A primary navigation option in this context may be an option that is correlated with a specific category, seller, product or similar content. In another embodiment, the system uses scrolling mechanisms, pulldown menus, rolling displays, pointing mechanisms, hot keys, enter commands or similar interfaces or navigation options. Navigation options that the alternative interface mechanisms may be applied to include ordinary navigation options and navigation options related to advertisements. Advertisements may be navigable content. The content of advertisements may be web based, specialized format or similar content. A navigation option related to an advertisement may be selected by a user in order to obtain a further matrix level containing further information or navigation options related to the advertisement. In a further embodiment, combinations of these interfaces or navigation options may be utilized. The simplified matrix navigation system is used herein with the exemplary interactive television shopping mechanism. Other interface and navigation options may be used in combination with or in place of the simplified matrix navigation system. The interfaces may be used with the email and search systems of the simplified navigation interface.

The interactive television shopping system utilizes the physical system of servers and clients described in regard to the simplified navigation system. The interactive television shopping system is not limited to use with televisions. The system may also be used with web devices, console systems (e.g., gaming systems, set top boxes, and similar systems) and similar devices. The communication data including matrix layer content, user data and similar information relevant to the system may be transmitted and received over a network as described in the previous exemplary embodiments. In another embodiment, other communication methods may be used to transmit at least a portion of the data related to the system. In one embodiment cable systems, telephone systems, cellular or wireless systems including wireless fidelity (WIFI) systems and similar communication systems may be used to deliver a navigation interface to a user, obtain data (e.g., purchase information) from a user, or compile user data from a set top box, television service providers or similar source.

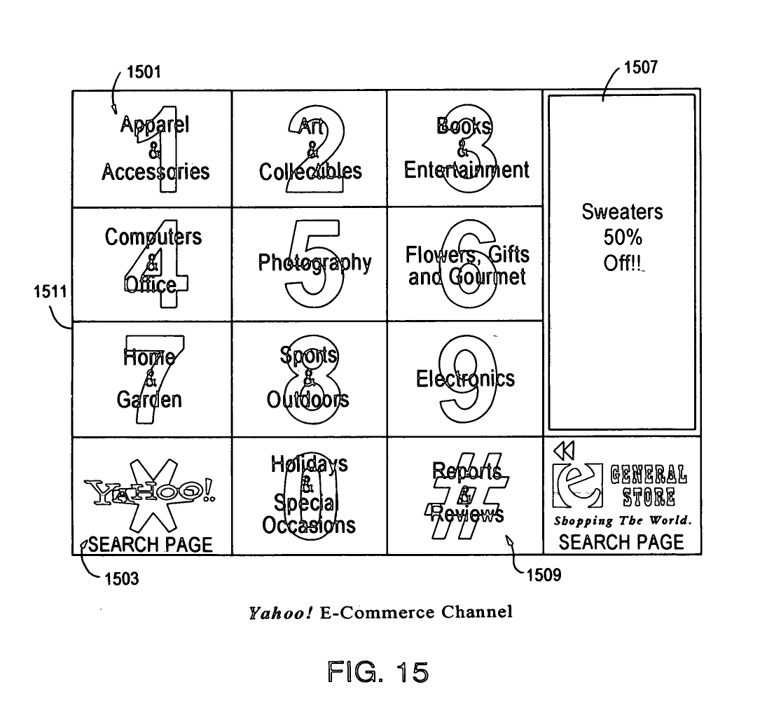

FIG. 15 is an illustration of a simplified navigation interface to be displayed on a television or similar display device. Matrix layer 1511 includes a set of navigation options intended to allow a simple search or browsing of products and services offered by a single or multiple manufacturers, retailers or distributors. Exemplary initial matrix layer 1511 may be a starting or top level matrix layer. In this embodiment, a user starts at this layer of the navigation hierarchy when shopping. Matrix layer 1511 includes a set of options that are each related to a unique input. The unique input may be received from a remote control, peripheral device or similar input mechanism. Each option corresponds to a broad classification of goods or services. For example, option ‘1’ 1501 is related to ‘Apparel & Accessories.’ Other options presented to a user include access to a search page 1503, access to reports and reviews 1509, access to a displayed advertisement 1507 and similar options. Each interface screen may include a limited set of options in order to maintain the overall simplicity of the navigation. A user selects an option presented at the top level matrix 1511, which results in a new matrix layer being generated based on that selection. In one embodiment, each matrix layer may present an option to display additional options at the same level of the navigation hierarchy. In a further embodiment, multiple top level or start matrices may be supported by the interactive television shopping network. Separate top level matrices may be related to separate television or sponsor channels and represent separate or interleaving navigable hierarchies of products.

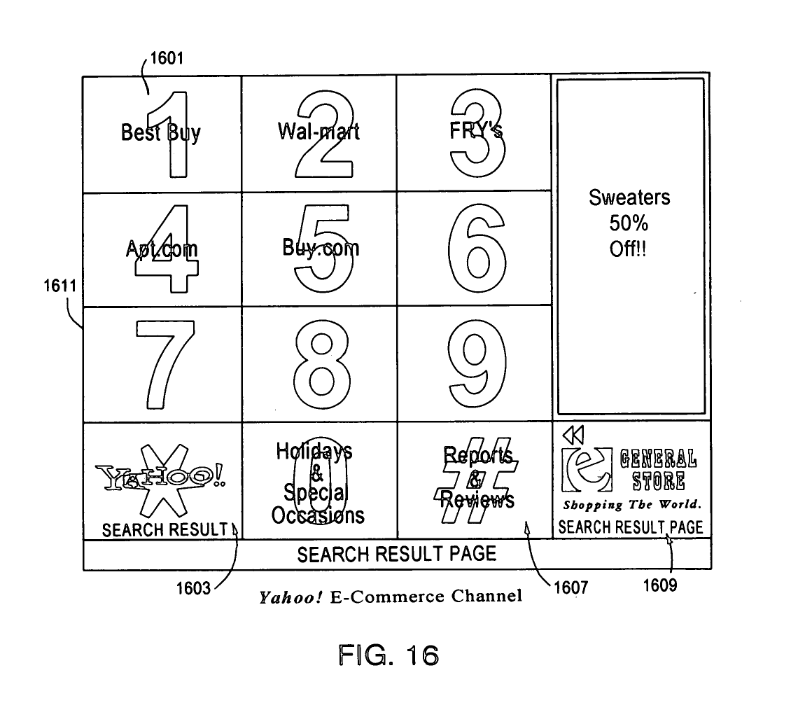

FIG. 16 is an illustration of an intermediate level of a navigation hierarchy. In one embodiment, matrix layer 1611 may be generated when a user selects a top level category. In another embodiment, matrix layer 1611 may be generated as a result of a search. Matrix layer 1611 includes a set of options corresponding to a set of sellers of products related to the category chosen from matrix layer 1511 or related to a keyword or other search indicator input into a search page. As used in the context of the interactive television shopping system a product may be a service offered by a seller or an item offered for sale by the seller. Sellers in this context may be retailers, distributors, manufacturers, processing centers or fulfillment houses offering products or service for sale. Matrix layer 1611 may present a set of sellers of electronics as options, option ‘9’ from top matrix layer 1511. Intermediate level matrix layer 1611 may include options offering a search page 1603, reports and review of material present in the matrix (e.g., stores, retailers and other sellers of merchandise), additional options and similar options. Matrix layer 1611 may also display advertisements 1609. Selecting an option from intermediate level matrix 1611, such as Best Buy 1601, may result in the generation of an additional intermediate level matrix with information that presents options with greater specificity. The navigation system may include any number of levels in its hierarchy. In another embodiment, the intermediate levels of matrices may include additional subcategories of products and services. In a further embodiment, sellers may be options in a top level matrix of a navigation hierarchy and the intermediate level matrices may include categories of products offered by the seller. Similar combinations of categories and seller options within the hierarchy may also be used.

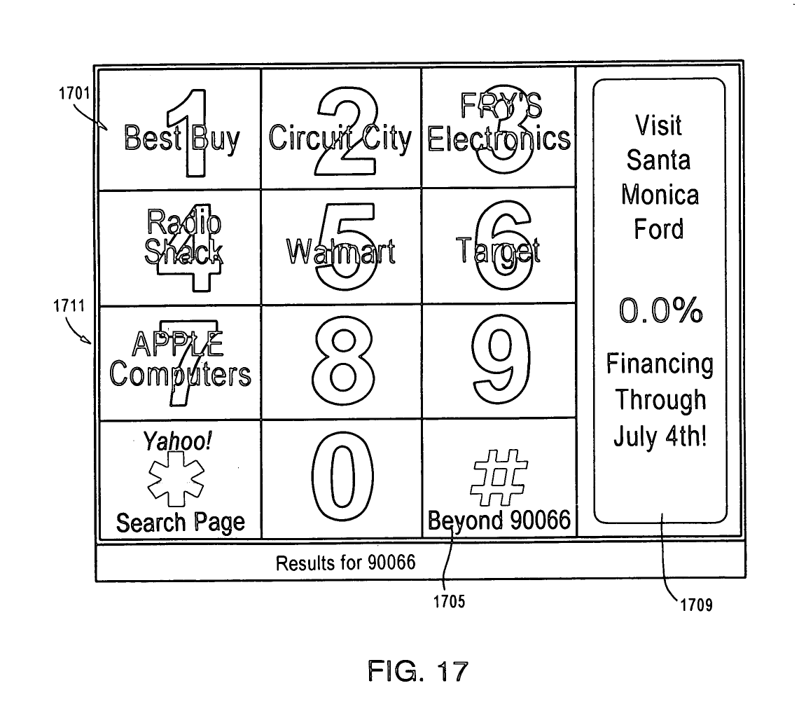

FIG. 17 is a diagram of an intermediate level of a simplified navigation interface for use in shopping in an interactive television system. In this embodiment, of the invention, sellers of products are presented that are related to the category of products selected from a top level matrix. In this embodiment, sellers are selected and displayed based on the location of a user. Sellers may be presented as options in a matrix layer if they are within a specified geographic distance from the location of a user. For example, in one exemplary embodiment, sellers sharing a zip code with the residence of a user are presented as options in the matrix layer. Matrix layer 1711 presents an exemplary embodiment of the invention, where a set of local electronics sellers are listed after the ‘Electronics’ option is selected at a top or higher level in the hierarchy than the current matrix layer 1711. In one embodiment, advertisement 1709 is present in matrix layer 1711. This advertisement may also be selected based on geographical proximity of the advertiser to the residence of the user. Additional sellers may be accessed by selecting an option 1705 that alters the geographical location or distance utilized by the system to find sellers local to the user. In one embodiment, the location of a user is obtained via a cable or set top box provider, subscription service provider or similar intermediary service provider. A user may call the interactive television shopping service provider to indicate the location of a user. In a further embodiment, the user may alter or set the location data including residence address, base search address for proximity determinations, proximity range and similar data through a settings screen or matrix layer accessible as an option from a layer of the hierarchical navigation system or through a set top box or similar physical device related to the interactive television system. In one embodiment, the user may switch between a local and national or regional presentation of content. The navigation interface may include an option that switches between a local and regional display.

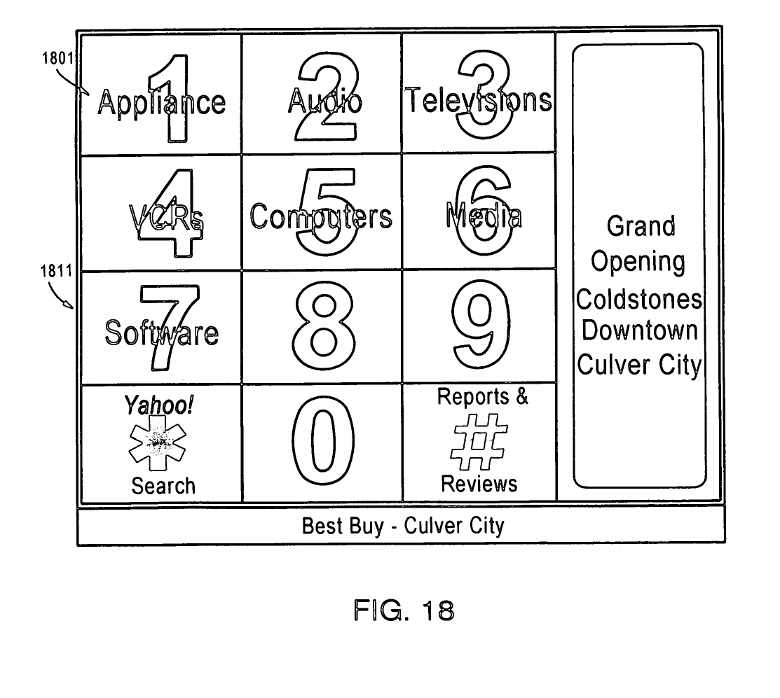

FIG. 18 is a diagram of an intermediate level of a hierarchical navigation interface for use in shopping in an interactive television system. Matrix layer 1811 is an exemplary embodiment of the invention where an intermediate level of the navigation hierarchy displays categories of goods and services offered by a seller. An option 1801 may be selected by a user to display a lower level matrix layer of the navigation hierarchy that lists the goods and services in that category offered by the seller. In one embodiment, the seller is a local seller and the categories, goods and services displayed as options for a user are available at the local seller's store or establishment. In one embodiment, each seller provides the interactive television shopping provider with inventories, lists and similar data detailing the goods and services available at each location of the seller. For example, matrix layer 1811 may be the matrix layer ‘below’ matrix layer 1711 where the ‘Best Buy’ option has been selected. Matrix layer 1811 includes a set of options 1801 related to the types of goods sold by Best Buy at its Culver City store which in this example is the closest store to a user having a zip code of 90066.

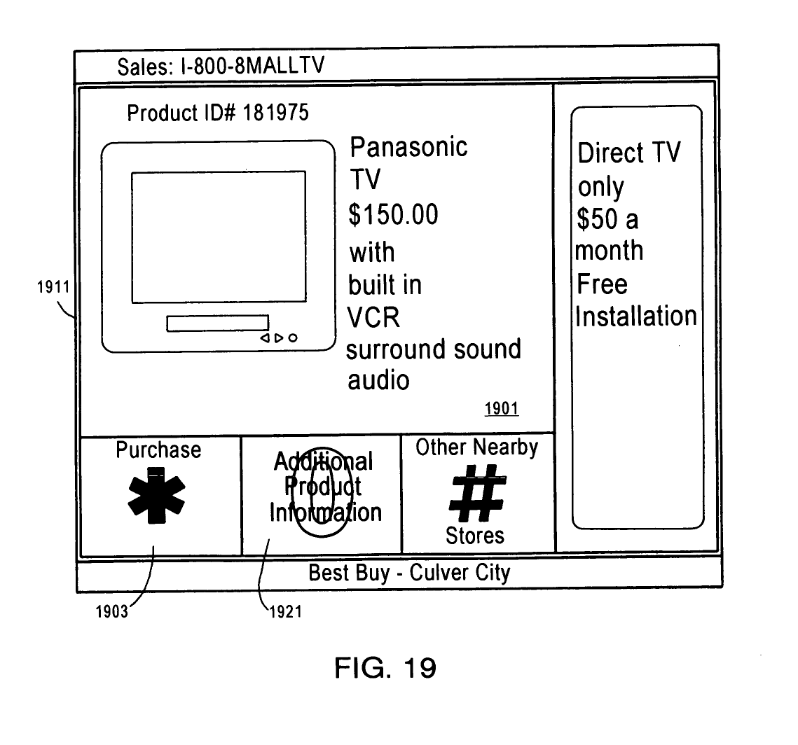

FIG. 19 is a diagram of a low level matrix of a hierarchical navigation interface for use in shopping in an interactive television system. Matrix layer 1911 includes a display section 1901 where details including price, product information, images, usage information and similar information regarding the product may be displayed. In one embodiment, the display section or other section of a matrix display, including an advertising option, may include audio or video content. The video or audio content may be played when a matrix layer is accessed. The video or audio may be replayed by selecting an option. Additional options such as an option 1921 to provide additional details regarding the product may be presented as well. Additional options may include but are not limited to availability of the product at a location or set of locations, a presentation of additional product information, a presentation of similar products, price comparisons at a set of stores and similar information. In one embodiment, the low level matrix 1911 includes an option 1903 to enable a user to initiate the purchase of the displayed item. In one embodiment, the navigation system tracks the items that a user has indicated an interest in purchasing. The navigation system may display an interface for inputting purchase information. In one embodiment, low level matrix layer 1911, or higher level matrix layers display contact information such as a telephone number for initiating a purchase of the products displayed via the navigation system.

In another embodiment, the content accessible in the interactive television shopping system may be accessible through other interfaces, including web browsers, specialized applications and similar interfaces. The content may be accessible through a personal computer, web appliance, hand held device or similar system. The content accessible through these systems may be filtered based on the location of a user. The location of the user may be input into the interface. This embodiment allows for the same access to searches, email, purchasing and other features of the matrix simplified navigation system.

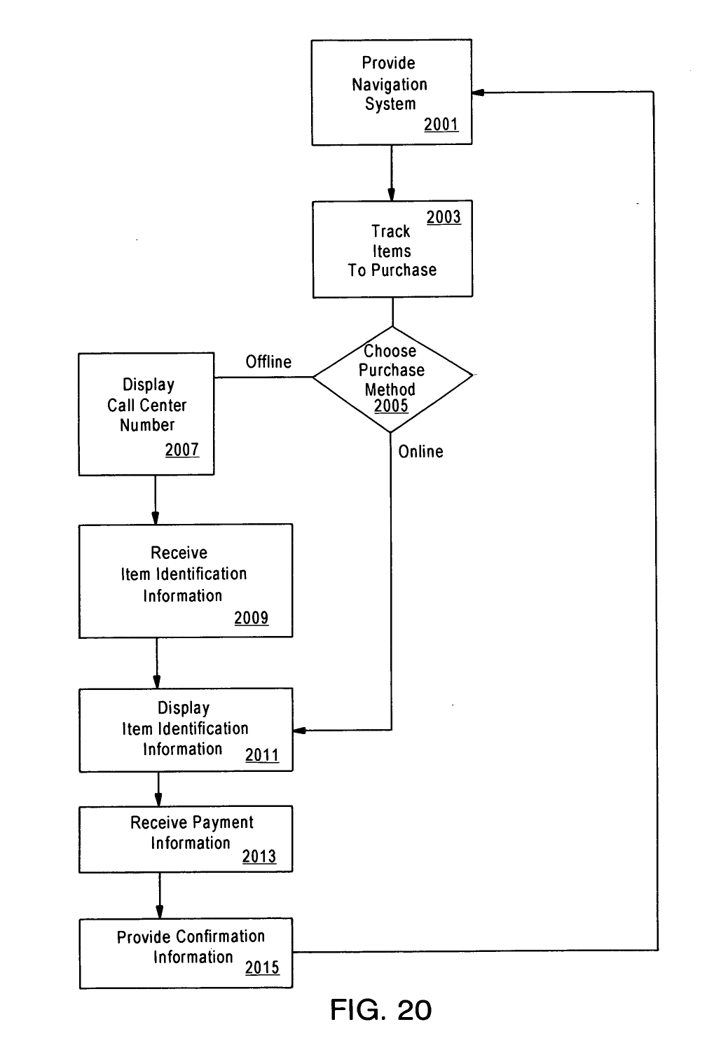

FIG. 20 is a flowchart depicting a system for enabling a user to purchase items using an interactive television shopping system, including enabling the purchase of multiple products from different sellers. In one embodiment of the invention, a simplified navigation system including a hierarchy of categorization for sellers and products is made available via a television, web appliance or similar display mechanism (block 2001). A user indicates the products that are desired to be purchased by selecting an option related to the product (block 2003). A user may indicate products to be purchased by selecting a corresponding option displayed in relation to the product to be purchased. In one embodiment, the user may select multiple products to be purchased, which are tracked by the navigation system provider. Navigation system provider may include options and displays that allow a user to manage the set of products that are to be purchased by a user. In one embodiment, the navigation system may display a list of products selected and allow a user to remove a product or modify the number of products to be purchased. Navigation system may maintain a shopping cart for each user.

When a user is prepared to complete a purchase of products that have been selected the user may select a method of purchasing the products (block 2005). The user may choose to utilize a displayed phone number to call a call center provided by navigation system provider (block 2007). A user may indicate the products to be purchased by informing a call center operator of a unique identifier for each product to be purchased. The navigation system assigns a unique identifier to each product in the hierarchy. In one embodiment, navigation system unique identifiers may indicate the product type, seller and similar information related to the product. The identifier may encode these details about a product. A call center operator records the unique identifiers for the products to be purchased by the user (block 2009).

In one embodiment, during the process of obtaining purchase data from the user the call center operator enters the data into the navigation and shopping system to generate a display screen sent to a user that displays the information provided by the user including the list of products selected by the user (block 2011). In one embodiment, the information obtained by the call center operator is by verbal communication. In another embodiment, information may be gathered with the assistance of electrical devices such as electronic card readers (e.g. credit card readers), facsimile devices or similar input or communication devices. The call center operator also obtains information needed to complete the purchase including but not limited to: credit card information, shipping address, quantity, warranty options, delivery options and similar purchasing information (block 2013). When a user calls a call center, data related to the user may be retrieved based on a matching of the user's telephone number with the data stored regarding that user. In another embodiment, the user may be identified by a personal identification number, through a system provider back channel, or similar system for associating a user with the navigation feed sent to the user. In an further embodiment, a telephone or voice communication system may be integrated with a console or similar system supporting the interactive television shopping service. The console includes identification information in the voice communications with the call center.

The purchase information given by the user, including payment information, product information and delivery information may also be displayed via the interactive television shopping system (block 2011). The user may be asked to confirm the purchase by reviewing the purchase information displayed through the interactive television system (block 2015). In another embodiment, the information is not displayed via the interactive television system.

A user may choose to complete a purchase using an online method. In this scenario the selected products are displayed via the interactive television system (block 2011). A user may confirm or edit the list of displayed products by removing or altering the amount of the products to be purchased. In one embodiment, the user may adjust the seller of a product to choose another seller that also provides the product. Alternate sellers may be available by selecting an option associated with a listed product. A user may confirm the purchase list provided by the interactive television system by selecting a confirmation option. Payment information may then be obtained though forms or similar interactive input mechanisms (block 2013). A user confirms the input information and the purchase is completed (block 2015).

In another embodiment, purchase information including payment information such as credit card numbers as well as shipping addresses and similar data is obtained through a cable or set top box service provider, subscription service provider or similar source. This information is stored by the interactive television shopping system provider and displayed when a user calls a call center or confirms a product list to be purchased. The user then confirms and may modify any of the data displayed by the system. When the user is satisfied that the information is correct the user may confirm the purchase information and the purchase will then be processed.

In a further embodiment, the call center may be automated using recorded voice messages and options that allow a user to enter personal and purchase information through a touch tone phone or similar mechanism. Products to be purchases may be identified by entering in the unique identifier associated with the product. The user may be presented with a series of options allowing them to choose between services offered by the automated call center including product purchasing, order status information, customer service and similar options. A user may elect to bypass the automated system by selecting to speak with a human operator. In one embodiment, the call center or automated call center may utilize a videophone, computer based phone or similar apparatus. In this embodiment, the call center operator or system present options for the user visually to be selected verbally by the user or through an input system such as a keypad.

Finalized purchases may cause interactive shopping television provider to forward the purchase information to the sellers of the products purchased by the user. Sellers may then fulfill the orders made by the user by reserving the items purchased at a designated store or by shipping the item to the user dependent on the delivery options selected by the user. Similarly, the system provider may handle billing of the purchases in a centralized manner or may distribute the purchases to the sellers and allow the sellers to separately bill a user for the products purchased. Billing may be coordinated through a call center, network server, local store, seller service center or similar establishment. Interactive television shopping system provider may have an established relationship with the seller such that the system provider may coordinate the shipping of the items and handle customer service including order returns, modifications, exchanges, shipping questions and similar matters.

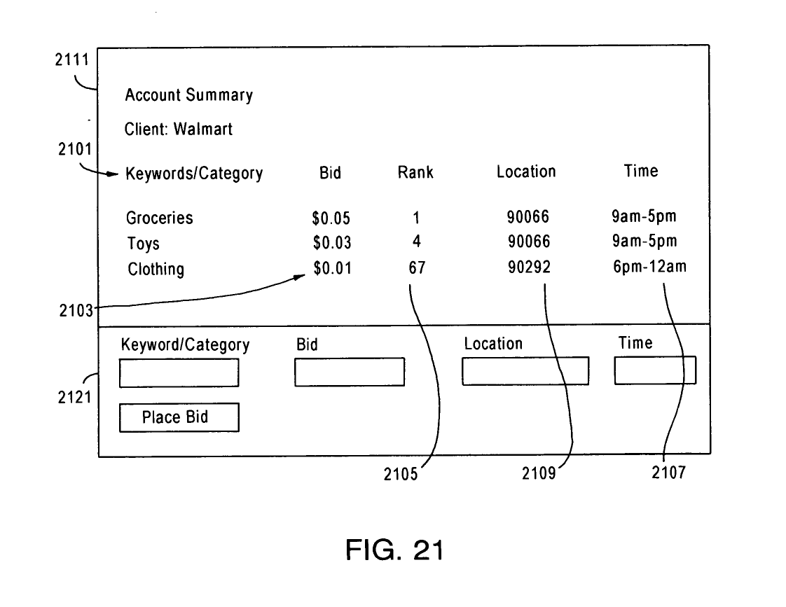

FIG. 21 is a diagram of an interface for the management of advertising and seller client accounts with the interactive television shopping system. In one embodiment, interactive television shopping network bases the order and level of sellers and advertisers in the navigation hierarchy on a set of factors including the bid by an advertiser or seller for a category, search keyword, location, time of day, date and similar factors. An advertiser may be a client that pays for the display of ads or listings in the navigation system. A seller may be a retailer, vendor, distributor, manufacturer, fulfillment house or similar entity that seeks to have its products and services listed in the navigation hierarchy.

In one embodiment, advertisers and sellers manage their accounts with the interactive television shopping system using interface 2111. An advertiser or seller may select a set of search keywords or hierarchy categories that a product is to be listed under or an advertisement to be displayed in connection with that keyword or category when it is input or selected by a user 2101. The advertiser or seller may place a bid for the use of the keyword or category 2103. This system may be a keyword auction system where keywords and categories are given to a highest bidder. Interactive television shopping provider may determine the order or frequency in which an advertisement, seller or product is displayed based on ranking the bids amongst the clients (i.e., advertisers and sellers) of the interactive television shopping provider 2105. The system of ranking or ordering the categories, sellers, products or similar content may be a bid for placement system where the placement of the content is determined by the bidding of the clients though the auction keyword system. In addition, an advertiser or seller may designate a geographic location to which an advertisement or product is tied 2109. Also, the product or advertisement display may further be dependent on a time frame designated by the advertiser or seller 2107. The bidding system may utilize any time frame for categorizing advertisements and listings. The time criteria may include date, day of the week, year, week, month, time of day, hour or similar unit of time or combinations thereof.

In this manner the advertiser or seller may closely target an intended audience or users that have known locations, shopping times or similar patterns of behavior. Other criteria that may be used to target advertising and product listings include, dates, shopper profile information, shopping cart information, related search or category designations and similar factors useful in targeting products and advertisements at a desired user group. For example, an ice cream store advertising using the interactive television shopping network may designate summer months, afternoon times, and locations within a seven mile radius of its store. An advertiser or seller may set separate bids for each permutation of the targeting criteria in order to set their bids in order to reach their target audience at a cost commensurate with expected returns. In one embodiment, bids are the rates for fees that are charged to clients of the interactive television shopping system provider based on the number of clicks, purchases, or similar performance indicators that result from the display of the seller or its products via the system. This system may be used for a pay for performance system where fees and billing to a client is based on the tracking of the performance data.

In another embodiment, flat fees for advertising related to keywords, categories, dates, times or other targeting criteria may be charged to a client. In one embodiment, a client may have a national or international account with the interactive television shopping provider. A national or international account places listings and advertisements on keyword search result pages, navigation matrix layers and similar displays of the system for user's in most or all locations that the service is provided. Advertisements and listings may be designated for any location type including countries, states, provinces, regions and similar locations. A client may also have a local account that allows a designation of advertisement or listings for a small regions such as a city, postal code area or similar region. A combination of local and national or international advertising and listings is also allowed by the system.

In one embodiment, account management interface 2111 includes an input and modification form or similar updating or modifying mechanism in order to add, cancel or modify the set of bids established by the client. In a further embodiment, the account management interface 2111 allows the monitoring and production of reports based on profiling information collected by the interactive television shopping system provider. In this embodiment, the system provider tracks the individual information of user including personal information such as age, gender, income and similar factors and correlates the information with the browsing pattern of the user and the purchases of the user. Additional information collected by the system includes but is not limited to times of shopping by users, locations of users, locations of purchases, related purchases of a user and similar information about a user and the user shopping patterns. This information may be used to allow advertisers and sellers to tailor their advertisements and product placement in the navigation systems in order to correlate their display with the browsing and purchase patterns of the users.

In a further embodiment, the navigation system and content of the interactive television shopping system may be utilized and displayed as a directory lookup service. The sellers are categorized by their service and goods. When a seller is selected, contact information including telephone, address and website information may be displayed. This system may be integrated with the interactive television shopping system or accessible as a separate system. The directory look up service may also have listings ordered according to a keyword auction system and utilizing a pay for performance system.

In a further embodiment, the interactive television shopping system may be used in conjunction with a auctioning system, reverse auctioning system or similar system for bidding on goods and services. The interactive television shopping system may also support providing a simplified navigation and interactive display for use with gaming systems including gaming systems that allow for gambling on events such as horse races, games such as blackjack, the lottery and similar services. The interactive television shopping and navigation system may also be used as an interface for providing access to online video games and similar services.

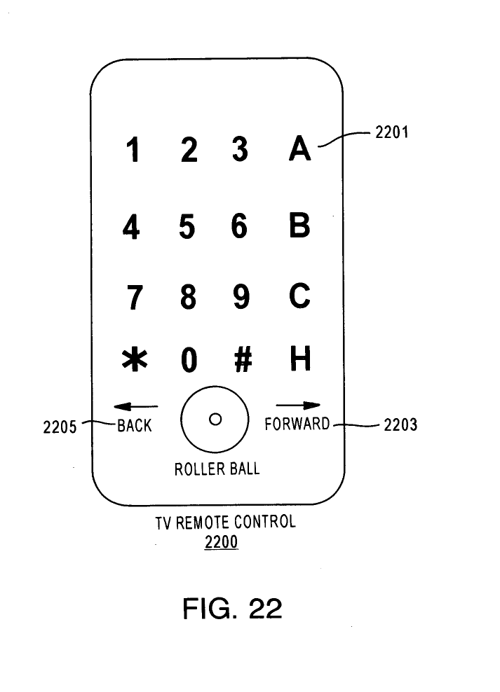

FIG. 22 is a diagram of input device 2200 for use with the simplified navigation system. Device 2200 may be a wireless device, utilizing IR communication, RF communication, wireless fidelity or similar modes of communication with a television set top device, console device, web appliance or similar system. Device 2200 includes a set of keys or buttons 2201 for generating unique inputs that correlate with displayed options of a navigation system. Device 2200 may have any number of keys 2201 including digit keys, alphanumeric keys, symbol keys or similar keys. Device 2200 may include specialized navigation keys 2205 such as a ‘back’ key; ‘forward’ key or similar key. In one embodiment, device 2200 may include a pointer device such as a roller ball 2203. Pointer device 2203 may be used to move a cursor over the navigation matrix layer in order to select an option. Device 2200 may include an enter key to confirm selections. In another embodiment, depressing pointer device 2203 functions as an enter key. In one embodiment, as the cursor moves over a navigation option the navigation option is highlighted by changing the color of the option, the color or contrast of the boarder of the option or through similar visual cues.

In another embodiment, a voice recognition or activation system may be used with the interactive television shopping system. A user may select a navigation option by audibly reciting the option. The option is recognized by the set top box, console, web appliance or similar device that displays the system over a television, liquid crystal display or similar display device.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A method comprising:
receiving a request for content;
determining content to be displayed based on a set of factors including a time and a location;
ranking the content based on a bid amount, the bid amount correlated to the time and the location; and
displaying the content in a rank pattern determined according to rank of the content.

2. The method of claim 1, wherein the content is a set of products.

3. The method of claim 1, wherein the content is a set of sellers.

4. The method of claim 1, wherein time is one of a date, hour of day, and day of week.

5. The method of claim 1, further comprising:
determining an advertisement to be displayed based on the set of factors; and
displaying the advertisement with the content.

6. The method of claim 1, further comprising:
obtaining a bid from a client through a web based interface.

7. The method of claim 1, further comprising:
displaying content that has a correlated location, the correlated location within a defined distance from a customer.

8. The method of claim 1, further comprising:
displaying content that has a correlated location that is a geographic region which a customer is within.

9. The method of claim 1, wherein the displaying of the content is through one of an interactive television system, web appliance, computer system and wireless device.

10. The method of claim 9, wherein the interactive television system utilizes a simplified navigation system.

11. A machine-readable medium that provides instructions, which when executed by a machine cause the machine to perform operations comprising:
receiving a request for content;
determining content to be displayed based on a set of factors including a time and a location;
ranking the content based on a bid amount, the bid amount correlated to the time and the location; and
displaying the content in a rank pattern determined according to rank of the content.

12. The machine-readable medium of claim 11, wherein the content is a set of products.

13. The machine-readable medium of claim 11, wherein the content is a set of sellers.

14. The machine-readable medium of claim 11, wherein time is one of a date, hour of day, and day of week.

15. The machine-readable medium of claim 11, which provides further instructions which when executed cause the machine to perform operations further comprising:
determining an advertisement to be displayed based on the set of factors; and
displaying the advertisement with the content.

16. The machine-readable medium of claim 11, which provides further instructions which when executed cause the machine to perform operations further comprising, further comprising:
obtaining a bid from a client through a web based interface.

17. The machine-readable medium of claim 11, which provides further instructions which when executed cause the machine to perform operations further comprising, further comprising:
displaying content that has a correlated location, the correlated location within a defined distance from a customer.

18. The machine-readable medium of claim 11, which provides further instructions which when executed cause the machine to perform operations further comprising, further comprising:
displaying content that has a correlated location that is a geographic region which a customer is within.

19. The machine-readable medium of claim 11, wherein the displaying of the content is through one of a web appliance, computer system, wireless device and interactive television system.

20. The machine-readable medium of claim 19, wherein the interactive television system utilizes a simplified navigation system.

21. A method comprising:
displaying a set of navigation options through an interactive television channel;
ranking navigation options based on a one of merchant feedback and user feedback; and
arranging navigation options based on ranking.

22. The method of claim 21, further comprising:
determining a placement of a matrix layer of a navigation interface based on ranking.
